(19) United States
(12) Patent Application Publication
(10) Pub. No.: US 2025/0370840 A1
(43) Pub. Date: Dec. 4, 2025

(54) KAFKA HEADER BASED SCHEMA MANAGEMENT IN ENCODING AND DECODING PERFORMANCE MANAGEMENT (PM)/FAULT MANAGEMENT (FM) DATA

(71) Applicant: RAKUTEN SYMPHONY, INC., Tokyo (JP)

(72) Inventor: Virendra REDDY, Bangalore (IN)

(21) Appl. No.: 18/262,729

(22) PCT Filed: Feb. 27, 2023
(86) PCT No.: PCT/US2023/013917

§ 371 Date: Jul. 25, 2023

(51) Int. Cl. G06F 11/07

(52) U.S. Cl. CPC G06F 11/0769; G06F 11/0727

(57) ABSTRACT

A Kafka header based schema version management in encoding and decoding Performance Management (PM)/Fault Management (FM) data. A microservice prepares one or more Encoding Type or Schema Version Tags based on one or more Encoding Type or Schema Source Files used by the microservice. The microservice encodes data using the Schema Version identified by the one or more Encoding Type or Schema Version Tags to produce encoded data, embeds the one or more Encoding Type or Schema Version Tags in a Header of a Kafka Message, and embeds the encoded data in the Message Body of the Kafka Message. The Microservices then sends the Kafka Message to a Northbound Management System for decoding based on the one or more Encoding Type or Schema Version Tags in the Header of the Kafka Message.

### TECHNICAL FIELD

This description relates to Kafka header based schema version management in encoding and decoding Performance Management (PM)/Fault Management (FM) data, and method of using the same.

### BACKGROUND

5G RAN is a set of virtualized networking technologies with advanced capabilities when compared to previous RAN standards. An Open Radio Access Network (O-RAN) is a totally disaggregated approach to deploying mobile fronthaul and midhaul networks built on cloud native principles. O-RAN is an evolution of the Next Generation RAN (NG-RAN) architecture. In a 5G O-RAN architecture, the 5G base station is restructured and split into three parts: Radio Unit (RU), Distributed Unit (DU) and Centralized Unit (CU).

The RU coverts radio signals sent to and from the antenna into a digital signal for transmission over packet networks. It handles the digital front end (DFE) and the lower PHY layer, as well as the digital beamforming functionality. The DU is deployed on site on a COTS server. DU software is normally deployed close to the RU. The CU is able to be deployed in the cloud to support the integrated deployment of core network and edge computing. The CU and DU are connected through an interface, and one CU is able to manage one or more DUs.

In the current 5G Open-Radio Access Network (O-RAN), a subsystem is implemented as a microservice. For example, a Radio Unit (RU) manager is a microservice which handles the transactions between the RU and a Distributed Unit (DU). Baseband microservice implements the layer-1 and layer-2 of the 5G stack. FCAPS microservices is a set of microservices which handle one aspect of the system, such as Fault Management, Configuration Management and Performance Management of the gNB NF.

Fault Management microservice (FM-MS) is responsible for collecting various events related to the functionality aspects (faults, error conditions, etc.) of the 5G O-RAN subsystems. FM-MS reports events immediately to a Northbound Management System for triggering any post-processing or corrective measures. Example FM-MS events include cell down, FIC link down, and timing locked.

Performance Management microservice (PM-MS) is responsible for collecting various statistics and counters related to performance aspects of the 5G O-RAN subsystems. PM-MS reports the performance statistics summary to the Northbound Management System at predefined regular intervals (e.g., every 1 min, 15 min, etc.). Example statistics provided by the PM-MS include throughput, active users, and cell uptime.

Thus, FM-MS handles just the Fault Management aspect, and PM-MS handles the Performance Management aspect. Depending on the software versions on the gNB Network Functions (NFs), various NFs might send PM data and FM data using different PM schema and FM schema variants. Northbound Management System (NBMS) is expected to know how to decode the NF's PM and FM data with different PM and FM schema versions. The Northbound Management System uses gNB inventory-based rules to decide the PM schema and FM schema based on the gNB NF's software version. The Northbound Management System uses internal APIs which map gNB NF's software version to PM schema and FM schema. The Northbound Management System has to determine from which gNB NF the PM data has arrived. Similarly, for the FM data. Currently, the Northbound Management System uses a workaround to solve this by creating multiple Kafka clusters or topics. A gNB NF with one version of PM/FM encoding type or schema sends the PM/FM data to one particular Kafka clusters/topics. And the PM/FM consumers in the Northbound Management System consume those per NF software version clusters/topics by decoding the PM/FM data. However, there can be multiple gNB software versions that have to be supported. Also, software versions at the NF level are able to be supported along with independent PM/FM microservice level software versions.

### SUMMARY

In at least embodiment, a method for providing Kafka header based schema version management includes preparing, by a microservice, one or more Management Tags including one or more of Encoding Type or Schema Version Tags based on one or more Encoding Type or Schema Source Files used by the microservice, encoding, by the microservice, data using one or more of Encoding Type or Schema Version identified by the one or more Encoding Type or Schema Version Tags to produce encoded data, embedding, by the microservice, the one or more Encoding Type or Schema Version Tags in a Header of a Kafka Message, embedding, by the microservice, the encoded data in the Message Body of the Kafka Message, and sending the Kafka Message to a Northbound Management System for decoding based on the one or more Encoding Type or Schema Version Tags in the Header of the Kafka Message.

In at least one embodiment, an apparatus providing Kafka header based schema version management includes a memory storing computer-readable instructions, and a processor connected to the memory, wherein the processor is configured to execute the computer-readable instructions to perform operations including preparing one or more Management Tags including one or more Encoding Type or Schema Version Tags based on one or more Encoding Type or Schema Source Files, encoding data using one or more of an Encoding Type or Schema Version identified by the one or more Encoding Type or Schema Version Tags to produce encoded data, embedding the one or more Encoding Type or Schema Version Tags in a Header of a Kafka Message, embedding the encoded data in a Message Body of the Kafka Message, and sending the Kafka Message to a Northbound Management System for decoding based on the one or more Encoding Type or Schema Version Tags in the Header of the Kafka Message.

In at least one embodiment, a non-transitory computer-readable media having computer-readable instructions stored thereon, which when executed by a processor causes the processor to perform operations including preparing, by a microservice, one or more Management Tags including one or more Encoding Type or Schema Version Tags based on one or more Encoding Type or Schema Source Files used by the microservice, encoding, by the microservice, data using a corresponding one or more Encoding Type or Schema Version identified by the one or more Encoding Type or Schema Version Tags to produce encoded data, embedding, by the microservice, the one or more Encoding Type or Schema Version Tags in a Header of a Kafka Message, embedding, by the microservice, the encoded data in the Message Body of the Kafka Message, and sending the Kafka Message to a Northbound Management System for decoding based on the one or more Encoding Type or Schema Version Tags in the Header of the Kafka Message.

### BRIEF DESCRIPTION OF THE DRAWINGS

Aspects of the present disclosure are best understood from the following detailed description when read with the accompanying figures. It is noted that, in accordance with the practice in the industry, various features are not drawn to scale. In fact, the dimensions of the various features are able to be increased or reduced for clarity of discussion.

FIG. 1 illustrates a mobile network according to at least one embodiment.

FIG. 2 illustrates Kafka communication reporting events to a Northbound Management System according to at least one embodiment.

FIG. 3 illustrates a Kafka message according to at least one embodiment.

FIGS. 4A-B illustrate Kafka Messages without Header Schema Identification.

FIG. 5 illustrates Kafka header based PM schema version management according to at least one embodiment.

FIG. 6 illustrates Kafka header based FM schema version management according to at least one embodiment.

FIGS. 7A-B illustrate Kafka Messages with Header Schema Identification according to at least one embodiment.

FIG. 8 is a flowchart of a method for Kafka header based schema version management according to at least one embodiment.

FIG. 9 is a high-level functional block diagram of a processor-based system according to at least one embodiment.

FIG. 10 is a high-level functional block diagram of a processor-based system according to at least one embodiment.

### DETAILED DESCRIPTION

Embodiments described herein describes examples for implementing different features of the provided subject matter. Examples of components, values, operations, materials, arrangements, or the like, are described below to simplify the present disclosure. These are, of course, examples and are not intended to be limiting. Other components, values, operations, materials, arrangements, or the like, are contemplated. For example, the formation of a first feature over or on a second feature in the description that follows include embodiments in which the first and second features are formed in direct contact and include embodiments in which additional features are formed between the first and second features, such that the first and second features are unable to make direct contact. In addition, the present disclosure repeats reference numerals and/or letters in the various examples. This repetition is for the purpose of simplicity and clarity and does not in dictate a relationship between the various embodiments and/or configurations discussed.

Further, spatially relative terms, such as “beneath,” “below,” “lower,” “above,” “upper” and the like, are used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus is otherwise oriented (rotated 90 degrees or at other orientations) and the spatially relative descriptors used herein likewise are interpreted accordingly.

Terms like “user equipment,” “mobile station,” “mobile,” “mobile device,” “subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, data streams or signaling-streams. The foregoing terms are utilized interchangeably in the subject specification and related drawings. The terms “access point,” “base station,” “Node B,” “evolved Node B (eNode B),” next generation Node B (gNB), enhanced gNB (en-gNB), home Node B (HNB),” “home access point (HAP),” or the like refer to a wireless network component or apparatus that serves and receives data, control, voice, video, sound, gaming, data streams or signaling-streams from UE.

In at least one embodiment, a method for providing Kafka header based schema version management includes preparing, by a microservice, one or more Management Tags including one or more Encoding Type or Schema Version Tags based on one or more Encoding Type or Schema Source Files used by the microservice, encoding, by the microservice, data using one or more Encoding Type or Schema Version identified by the one or more Encoding Type or Schema Version Tags to produce encoded data, embedding, by the microservice, the one or more Encoding Type or Schema Version Tags in a Header of a Kafka Message, embedding, by the microservice, the encoded data in the Message Body of the Kafka Message, and sending the Kafka Message to a Northbound Management System for decoding based on the one or more Encoding Type or Schema Version Tags in the Header of the Kafka Message.

PM/FM data is associated with corresponding one or more Management Tags including one or more Performance Management (PM)/Fault Management (FM) Encoding Type or Schema Version Tags which can be used by a Northbound Management System to decode the respective data. Embodiments described herein provide method that provides one or more advantages. For example, the Kafka Header Based one or more Encoding Type or Schema Version Management according to at least one embodiment has the ability to manage different versions of microservice software and is scalable because different microservices are able to run with the different one or more PM Encoding Type or Schema, one or more FM Encoding Type or schema, etc. The one or more PM/FM Encoding Type or Schema Version Tags are embedded in the Kafka Message Header along with the encoded PM/FM data in the Kafka message body. Kafka header based encoding type and schema version management is microservice oriented and does not depend on the software version of the gNB NFs. Instead the Performance Management Microservice (PM MS)/Fault Management Microservice (FM MS) self publishes its schema to the Northbound Management System. The implementation and use of decode logic at the Northbound Management System is based on a simple Kafka header check. The Northbound Management System is able to decode with the decoder corresponding to the Encoding Type and Schema Version identified by the Tags in the Kafka Message Header. The Northbound Management System is able to be a simpler implementation that does not rely on complicated logic of handling the inventory, and the encoding type and schema version logic, etc. The process involves a simple header check, and then logic for choosing the decoder according to the Tags in the Kafka Message Header.

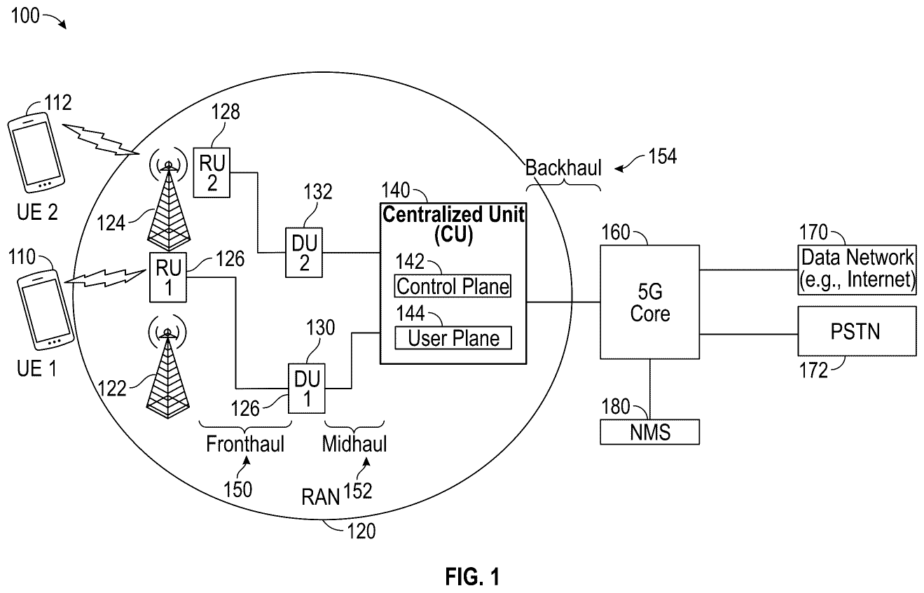

FIG. 1 illustrates a mobile network 100 according to at least one embodiment.

In FIG. 1, UE 1 (User Equipment 1) 110 and UE 2 112 access Mobile Network 100 via a Radio Access Network 120.

Radio Access Network 120 includes Radio Towers 122, 124. Radio Towers 122, 124 are associated with RU (Radio Unit) 1 126 and RU 2 128. RU 1 126 and RU 2 128 handle the Digital Front End (DFE) and the parts of the PHY layer, as well as the digital beamforming functionality. RU 1 126 is associated with Distributed Unit (DU) 1 130 and RU 2 128 is associated with DU 2 132. DU 1 130 and DU 2 132 are responsible for real time Layer 1 and Layer 2 scheduling functions. For example, in 5G, Layer-1 is the Physical Layer, Layer-2 includes the Media Access Control (MAC), Radio link control (RLC), and Packet Data Convergence Protocol (PDCP) layers, and Layer-3 (Network Layer) is the Radio Resource Control (RRC) layer. Layer 2 is the data link or protocol layer that defines how data packets are encoded and decoded, how data is to be transferred between adjacent network nodes. Layer 3 is the network routing layer and defines how data is moves across the physical network.

DU 1 130 and DU 2 132 are coupled to the RU 1 126 and RU 2 128, respectively, and run the RLC, MAC, and parts of the PHY layer. DU 1 130 and DU 2 132 include a subset of the eNB/gNB functions, depending on the functional split option, and operation of DU 1 130 and DU 2 132 are controlled by Centralized Unit (CU) 140. CU 140 is responsible for non-real time, higher L2 and L3. Server and relevant software for CU 140 is able to be hosted at a site or is able to be hosted in an edge cloud (datacenter or central office) depending on transport availability and the interface for the Fronthaul 150. The server and relevant software of CU 140 is also able to be co-located at DU 1 130 or DU 132, or is able to be hosted in a regional cloud data center.

CU 140 handles the RRC and PDCP layers. The gNB includes CU 140 and one or more DUs, e.g., DU 1 130, connected to CU 140 via Fs-C and Fs-U interfaces for a Control Plane (CP) 142 and User Plane (UP) 144, respectively. CU 140 with multiple DUs, e.g., DU 1 130, and DU 2 132, support multiple gNBs. The split architecture enables a 5G network to utilize different distribution of protocol stacks between CU 140, and DU 1 130 and DU 2 132, depending on network design and availability of the Midhaul 152. While two connections are shown between CU 140 and DU 1 130 and DU 2 132, CU 140 is able to implement additional connections to other DUs. CU 150, in 5G. is able to implement, for example, 256 endpoints or DUs. CU 140 supports the gNB functions such as transfer of user data, mobility control, RAN sharing (MORAN), positioning, session management etc. However, one or more functions are able to be allocated to the DU. CU 140 controls the operation of DU 130 and DU 132 over the Midhaul interface 152.

Backhaul 154 connects the 4G/5G Core 160 to the CU 140. Core 160 may be up to 200 km away from the CU 140. Core 160 provides access to voice and data networks, such as Internet 170 and Public Switched Telephone Network (PSTN) 172. Network Management Services (NMS) 180 are able to communicate with CU 140 and Core 160.

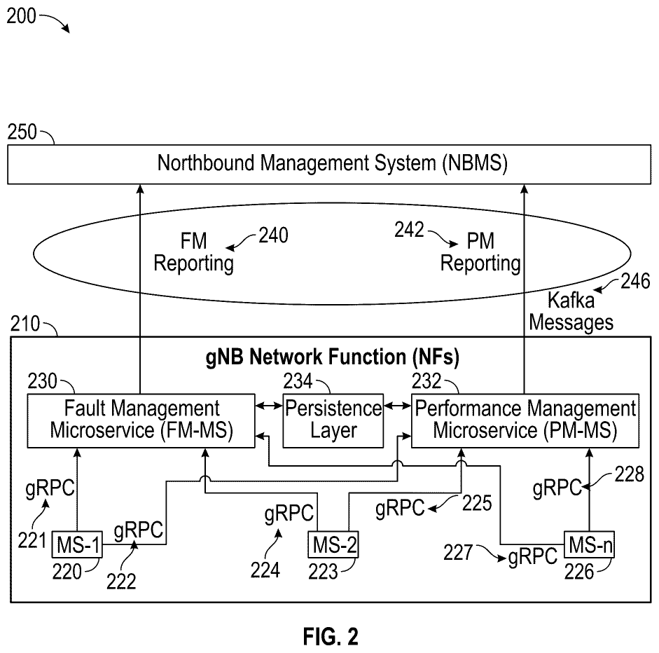

FIG. 2 illustrates Kafka communication 200 reporting events to a Northbound Management System according to at least one embodiment.

In FIG. 2, gNB Network Functions (NFs) 210 are shown reporting events to the Northbound Management System (NBMS) 250. The gNB Network Functions (NFs) 210 implements Microservice 1 (MS-1) 220, Microservice 2 (MS-2) 223, and Microservice n (MS-n) 226. In a current 5G Open-Radio Access Network (O-RAN), a subsystem is implemented as a microservice. For example, a Radio Unit (RU) manager is a microservice which handles the transactions between the RU and a Distributed Unit (DU). MS-1 220, MS-2 223, MS-n 226 communicate with a Fault Management Microservice (FM-MS) 230 using gRPC (Google Remote Procedure Calls) 221, 224, 227, respectively. MS-1 220, MS-2 223, MS-n 226 communicate with a Performance Management Microservice (PM-MS) 232 using gRPCs 222, 225, 228, respectively.

The gRPC interfaces 221, 222, 224, 225, 227, 228 implement lightweight and high-performance communication protocols based on protocol buffers to serialize structured data.

A Persistence Layer 234 is implemented to provide resiliency for FM-MS 230 and PM-MS 232. Microservices, whether FM-MS 230 or PM-MS 232, are bound to restart at some time. For example, in response to something going wrong, one or more of FM-MS 230 or PM-MS 232 are killed and then restarted. The data that was available to FM-MS 230 and PM-MS 232 just before being killed or restarted is persisted by Persistence Layer 234. Thus, even in response to a FM-MS 230 or PM-MS 232 being killed or restarted, FM-MS 230 and PM-MS 232 are able to process that data which was in a previous instance. Thus, the Persistence Layer 234 is used as a backup, and the Persistence Layer 234 enables FM-MS 230 and PM-MS 232 to continue where the previous instance left off. Upon a FM-MS 230 or PM-MS 232 restarting, the FM-MS 230 and PM-MS 232 read the Persistence Layer 234 and obtains the state information and other information to continue operation.

Baseband microservice implements the layer-1 and layer-2 of the 5G stack. FCAPS microservices is a set of microservices which handle one aspect of the system, such as FM-MS 230 and PM-MS 232 of the gNB NFs 210. FM-MS 230 is responsible for collecting various events related to the functionality aspects (faults, error conditions, etc.) of the 5G O-RAN subsystems. FM-MS 230 reports events via FM Reporting 240 to Northbound Management System 250 for triggering any post-processing or corrective measures. Example events reported by FM-MS 230 include cell down, F1-C link down, and timing locked. F1-C provides the inter-connection between CU Control Plane (CU-CP) and a DU. PM-MS 232 is responsible for collecting various statistics and counters related to performance aspects of the 5G O-RAN subsystems. PM-MS 232 reports the performance statistics summary via PM Reporting 242 to the Northbound Management System 250 at predefined regular intervals (e.g., every 1 min, 15 min, etc.). Example statistics provided by the PM-MS 232 include throughput, active users, and cell uptime. FM Reporting 240 and PM Reporting 242 is provided to Management System 250 using a Kafka Messages 246.

Thus, FM-MS 230 handles the Fault Management aspect, and PM-MS 232 handles the Performance Management aspect. The gNB NFs 210 is able to send encoded PM data and FM data using different PM schema and FM schema variants. The amount of PM data is able to be large, e.g., 100 megabytes (MBs). The FM data is able to reach tens of MBs, e.g., 50 MBs. The PM and FM data is encoded to compress the data to reduce the utilization of network resources. The encoded data is able to be compressed to reduce the utilization of network resources, e.g., to 4-10 MBs.

Northbound Management System 250 is the consumer of the data and is expected to know how to decode the PM and FM data with different PM and FM schema versions received from the gNB NFs 210. The Northbound Management System 250 uses gNB inventory-based rules to decide the PM schema and FM schema based on the software version used by the gNB NFs 210. The Northbound Management System 250 uses internal APIs which map the software version used by the gNB NFs 210 to PM schema and FM schema. The Northbound Management System 250 determines from which of FM-MS 230 and PM-MS 232 of the gNB NFs 210 the PM and FM data has arrived. The Northbound Management System 250 thus involves determining the schema to decode the data and then consume the data. For example, the Northbound Management System 250 processes the data according to the determined schema and presents the date on a User Interface (UI). Accordingly, the encoding is performed by the gNB NFs 210, and the decoding is performed by the Northbound Management System 250.

The schema is able to change occasionally based on, for example, changes in software versions. The gNB NFs 210 are is able to send or update the schema version at a later point in time to suit the latest version. Depending on the software versions on the gNB NF 210, various NFs are able to send encoded PM data and FM data using different PM schema and FM schema variants. The Northbound Management System 250 has to be able to decode the PM and FM data with different PM and FM schema versions. The change in schema version presents a compatibility issue with respect to the Northbound Management System 250. The Northbound Management System 250 is able to decode a schema version 1.0. However, one of the gNB NFs 210 sends data using a schema version 1.0, while other of the gNB NFs 210 send data using a different schema version, e.g., schema version 1.1, 1.2, 1.3, etc. Thus, the Northbound Management System 250 has to work with different variants of schema to decode the data. The presents a problem where the Northbound Management System 250 has to identify the schema that was used to import the data. In the CNF (cloud-native network function) based 5G O-RAN implementation, the microservices have to be available in quick working condition to avoid any impact on the overall functioning of the RAN.

In response to new software version being used, the new software version is communicated as a release note or a similar notification. Thus, the gNB NFs 210 implement the appropriate logic for the new software version. Implementing processing for different schema versions is a tedious process in the Northbound Management System 250. Decoding the data properly involves the new software version being mapped to the new schema version. The Northbound Management System 250 uses a table and logic to identify what schema version to use. Different software versions are to be mapped to different schema versions. Currently, the schema version is not identified in the Kafka Messages 246 because the message body is sent. Another problem is that this process is not scalable.

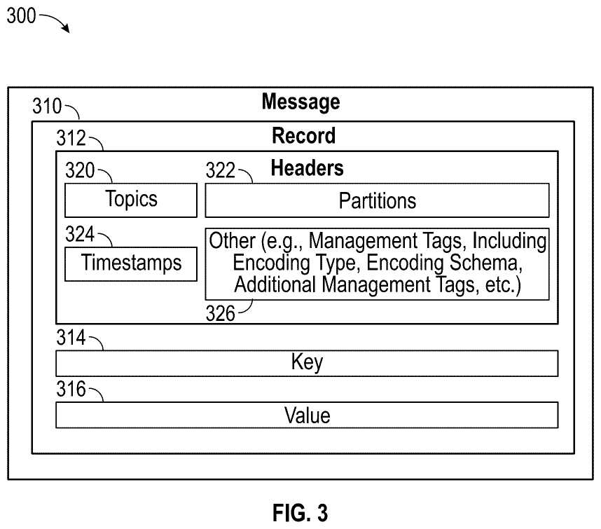

FIG. 3 illustrates a Kafka message 300 according to at least one embodiment.

In FIG. 3, Kafka message 300 are also known as a Record 310. A Record 310 includes Headers 312, Keys 314, and Values 316. Kafka Message 300 is created by a producer, e.g., a Fault Management Microservice (FM-MS) or a Performance Management Microservice (PM-MS). A Header 312 identifies metadata about the Kafka record, without adding any extra information to the Keys 314, and Values 316 of the Record 310. Data is read or written to Kafka Messages 300 in the form of events. An event includes metadata provided in the Header 312, such as Topics 320, Partitions 322, Timestamps 324, and Other Metadata 326 (e.g., Schema identifier as described below), as well as Keys 314 and Values 316. Events are organized and durably stored in Topics 320. A Topic 320 is similar to a folder in a filesystem, and the events are the files in that folder. Topics 320 are made of Partitions 322. Keys 314 and Values 316 interact in specific ways to serialize or deserialize data.

A producer is able to send data to different Partitions 322 at a Northbound Management System, and Key 314 and Values 316 are included to identify what partition data is to be sent. For example, data for a first pair of Key 314 and Values 316, key_123, is designated for being sent to Partition 0, and data for a second pair of Key 314 and Values 316, key_456, is designated for being sent to Partition 1. As described in more detail below, Header 312 is also able to be used to provide information for identifying the schema version that is used to decode the Kafka Message 300 that is received by the Northbound Management System.

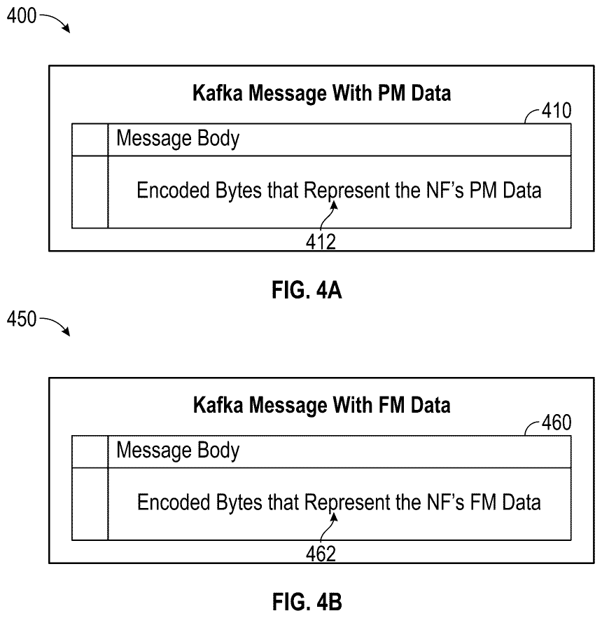

FIGS. 4A-B illustrate Kafka Messages 400, 450 without Header Schema Identification.

In FIG. 4A, Kafka Message 400 includes PM data. Kafka Message 400 includes the Message Body 410. Message Body 410 is shown including Abstract Syntax Notation One (ASN.1) encoded bytes 412. Encoded data is sent by a PM MS using ASN.1 encoded bytes 412 to the Northbound Management System over the Kafka transport.

In FIG. 4B, Kafka Message 450 includes FM data. Kafka Message 400 includes the Message Body 460. Message Body 460 is shown including JSON encoded bytes 462. Encoded data is sent by an FM MS using JSON encoded data 462 to the Northbound Management System over the Kafka transport.

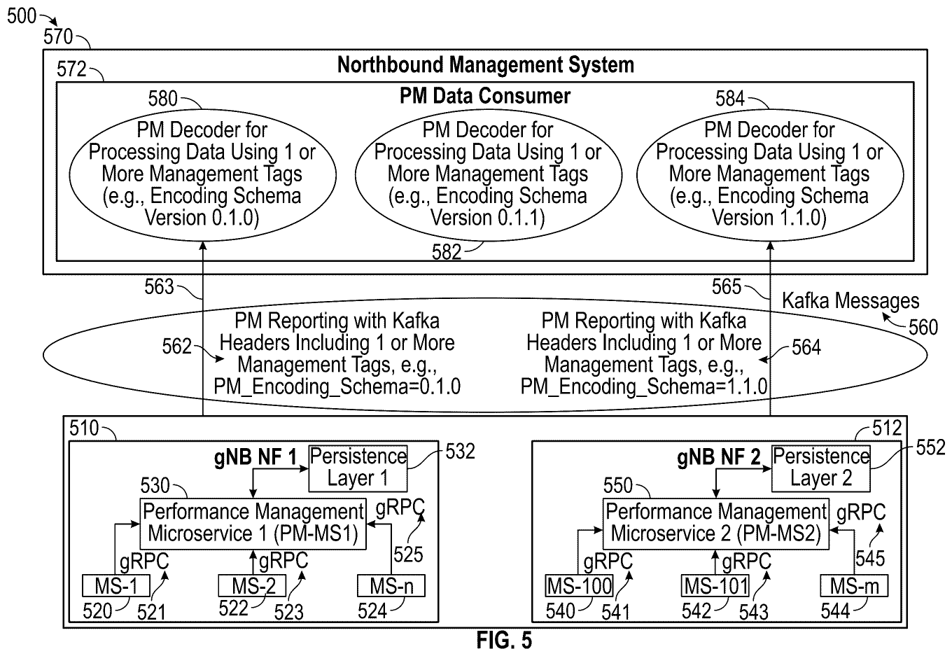

FIG. 5 illustrates Kafka header based PM schema version management 500 according to at least one embodiment.

In FIG. 5, gNB NF 1 510 and gNB NF 2 512 are shown providing Kafka Messages 560 to Northbound Management System (NBMS) 570. The gNB NF 1 510 includes Microservice 1 (MS-1) 520, MS-2 522, and MS-n 524. MS-1 520, MS-2 522, MS-n 524 communicate with Performance Management Microservice 1 (PM-MS1) 530 using a gRPC (Google Remote Procedure Call) interfaces 521, 523, 525, respectively. The gRPC interfaces 521, 523, 525 implement lightweight and high-performance communication protocols based on protocol buffers to serialize structured data. A Persistence Layer 532 is implemented to provide resiliency for PM-MS 530.

The gNB NF 2 512 includes Microservice 100 (MS-100) 540, MS-101 542, and MS-m 544. MS-100 540, MS-101 542, MS-m 544 communicate with Performance Management Microservice 2 (PM-MS2) 550 using a gRPC interfaces 541, 543, 545, respectively. The gRPC interfaces 541, 543, 545 implement lightweight and high-performance communication protocols based on protocol buffers to serialize structured data. A Persistence Layer 552 is implemented to provide resiliency for PM-MS 530.

Kafka Messages 560 are sent to PM Data Consumer 572 of Northbound Management System 570 by PM-MS1 530 and PM-MS2 550. PM Data Consumer 572 includes different PM Decoders. In FIG. 5, PM Data Consumer 572 includes PM Decoder for processing data using one or more Management Tags (e.g., Encoding Schema Version 0.1.0 580, PM Decoder for processing data using one or more Management Tags (e.g., Encoding Schema Version 0.1.1 582, and PM Decoder for processing data using one or more Management Tags (e.g., Encoding Schema Version 1.1.0 584. For example, a Kafka Cluster at Northbound Management System 570 is able to have multiple topics that can be created: one topic for version 1.1, another topic for version 1.2, another for version 1.3, etc. To create a topic, the Kafka configuration is changed and partitions are created. Northbound Management System 570 is also able to include a broker that listens on the different topics though decoder logic. Thus, the decoder logic is able to be independent of the system. However, a task of the Northbound Management System 570 is to identify which decoder to send the encoded PM data to for proper decoding of the encoded PM data.

Kafka Message 563 provides PM Reporting with Kafka Headers that include one or more Management Tags, e.g., PM_Encoding_Schema=0.1.0 562. The PM Schema Version Tag is embedded in the Kafka Message Header along with the encoded PM data in the Kafka message body. Thus, the Kafka Message 563 is analyzed by PM Data Consumer 572 of Northbound Management System 570 to determine the encoding schema used by Kafka Message 563. PM Data Consumer 572 of Northbound Management System 570 is able to determine that Kafka Message 563 provides PM Reporting with Kafka Headers that includes one or more Management Tags, e.g., PM_Encoding_Schema=0.1.0 562, and thus decodes Kafka Message 563 using PM Decoder for processing data using one or more Management Tags (e.g., Encoding Schema Version 0.1.0 580.

Kafka Message 565 provides PM Reporting with Kafka Headers that include one or more Management Tags, e.g., PM_Encoding_Schema=1.1.0 564. Thus, the Kafka Message 565 is analyzed by PM Data Consumer 572 of Northbound Management System 570 to determine the encoding schema used by Kafka Message 565. PM Data Consumer 572 of Northbound Management System 570 is able to determine that Kafka Message 565 provides PM Reporting with Kafka Headers that includes one or more Management Tags, e.g., PM_Encoding_Schema=0.1.1 564, and thus decodes Kafka Message 565 using PM Decoder for processing data using one or more Management Tags (e.g., Encoding Schema Version 1.1.0 584.

PM-MS1 530 and PM-MS2 550 prepare the one or more Management Tags including the one or more PM Encoding Type or Schema Version Tags based on the one or more Encoding Type or Schema Source Files and the encoding used. PM-MS1 530 and PM-MS2 550 encode the PM data using the one or more PM Encoding Type or Schema identified by the one or more PM Encoding Type or Schema Version Tags. PM-MS1 530 and PM-MS2 550 embed the one or more Management Tags including the one or more PM Encoding Type or Schema Version Tags in the Kafka Message Headers and embed the encoded PM data in the body of the Kafka Messages 560. PM-MS1 530 and PM-MS2 550 then send the Kafka Messages 560 to the Northbound Management System 570. The Northbound Management System 570 reads the one or more Management Tags including the one or more PM Encoding Type or Schema Version Tags from the Kafka Message Headers. The Northbound Management System 570 then processes the PM data using any Additional Management Tags, and decodes the PM data in the Kafka Messages 560 using a decoder corresponding to the one or more PM Encoding Type or Schema identified by the one or more PM Encoding Type or Schema Version Tags from the Kafka Message Headers of the Kafka Messages 560. PM-MS1 530 and PM-MS2 550 then process the next PM data for the next Kafka Message 560 sent to the Northbound Management System 570.

The Additional Management Tags are able to be added in each of PM/FM Kafka Messages 560 to help the Northbound Management System (NBMS) 570 make decisions or to handle the data with priority etc. before the NBMS 570 even begins decoding the actual PM/FM data. Examples of Additional Management Tags include one or more of a Base Station Identifier (ID) Tag, an Event Timestamp Tag, or a ROP (Reporting Output Period) Timestamp Tag.

For example, a Base Station Identifier (ID) Tag, such as for gNB/eNB ID, is able to be included in the Kafka Message Header to help monitor data from a particular base station, e.g., high priority cell sites, such as VIP areas, etc. A Base Station Identifier (ID) Tag is able to include one or more of gNB=<gNB id> or eNB=<id>. An Event Timestamp Tag for PM data is able to be included in the Kafka Message Header for sharing by the gNB/eNB with the NBMS 570 to convey a sense of priority for processing the events, e.g., in response to the NBMS 570 processing more than one Kafka data message. An Event Timestamp Tag is able to include Timestamp=<timestamp>. A ROP (Reporting Output Period) Timestamp Tag for PM data is able to be included in the Kafka Message Header to identify a begin/end timestamp of the measurement period. The ROP Timestamp Tag helps the PM engine of the NBMS 570 know the PM data's timestamp, which is located in the body of the Kafka messages 560. A ROP Timestamp Tag is able to include ROP=<timestamp>.

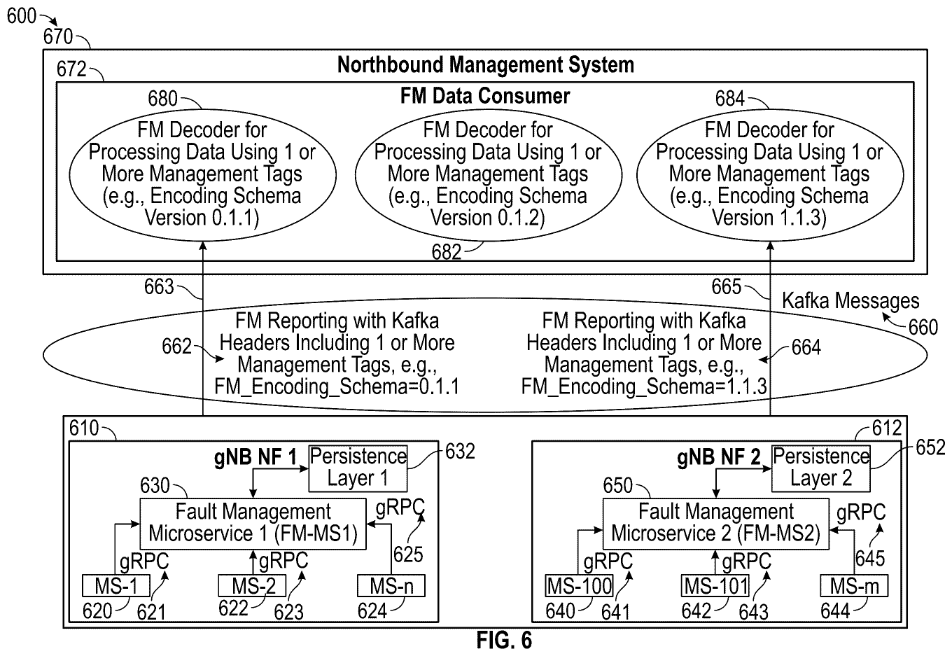

FIG. 6 illustrates Kafka header based FM schema version management 600 according to at least one embodiment.

In FIG. 6, gNB NF 1 610 and gNB NF 2 612 are shown providing Kafka Messages 660 to Northbound Management System 670. The gNB NF 1 610 includes Microservice 1 (MS-1) 620, MS-2 622, and MS-n 624. MS-1 620, MS-2 622, MS-n 624 communicate with Fault Management Microservice 1 (FM-MS1) 630 using a gRPC (Google Remote Procedure Call) interfaces 621, 623, 625, respectively. The gRPC interfaces 621, 623, 625 implement lightweight and high-performance communication protocols based on protocol buffers to serialize structured data. A Persistence Layer 632 is implemented to provide resiliency for FM-MS 630.

The gNB NF 2 612 includes Microservice 100 (MS-100) 640, MS-101 642, and MS-m 644. MS-100 640, MS-101 642, MS-m 644 communicate with Fault Management Microservice 2 (FM-MS2) 650 using a gRPC interfaces 641, 643, 645, respectively. The gRPC interfaces 641, 643, 645 implement lightweight and high-performance communication protocols based on protocol buffers to serialize structured data. A Persistence Layer 652 is implemented to provide resiliency for FM-MS 630.

Kafka Messages 660 are sent to FM Data Consumer 672 of Northbound Management System 670 by FM-MS1 630 and FM-MS2 650. FM Data Consumer 672 includes different FM Decoders. In FIG. 6, FM Data Consumer 672 includes FM Decoder for processing data using one or more Management Tags, e.g., Schema Version 0.1.1 680, FM Decoder for processing data using one or more Management Tags, e.g., Schema Version 0.1.2 682, and FM Decoder for processing data using one or more Management Tags, e.g., Schema Version 1.1.3 684. As described above with reference to FIG. 5, a Kafka Cluster at Northbound Management System 670 is able to have multiple topics that can be created: one topic for version 01.1, another topic for version 0.1.2, another for version 1.1.3, etc. To create a topic, the Kafka configuration is changed and partitions are created. Northbound Management System 670 is also able to include a broker that listens on the different topics though decoder logic. Thus, the decoder logic is able to be independent of the system. However, a task of the Northbound Management System 670 is to identify which decoder to send the encoded FM data to for proper decoding of the encoded FM data.

Kafka Message 663 provides FM Reporting with Kafka Headers that include one or more Management Tags, e.g., FM_Encoding_Schema=0.1.1 662. The FM Schema Version Tag is embedded in the Kafka Message Header along with the encoded FM data in the Kafka message body. Thus, the Kafka Message 663 is analyzed by FM Data Consumer 672 of Northbound Management System 670 to determine the encoding schema used by Kafka Message 663. FM Data Consumer 672 of Northbound Management System 670 is able to determine that Kafka Message 663 provides FM Reporting with Kafka Headers that includes one or more Management Tags, e.g., FM_Encoding_Schema=0.1.1 662, and thus decodes Kafka Message 663 using FM Decoder for processing data using one or more Management Tags, e.g., Encoding Schema Version 0.1.1 680.

Kafka Message 665 provides FM Reporting with Kafka Headers that include one or more Management Tags, e.g., FM_Encoding_Schema=1.1.3 664. Thus, the Kafka Message 665 is analyzed by FM Data Consumer 672 of Northbound Management System 670 to determine the encoding schema used by Kafka Message 665. FM Data Consumer 672 of Northbound Management System 670 is able to determine that Kafka Message 665 provides FM Reporting with Kafka Headers that includes one or more Management Tags, e.g., FM_Encoding_Schema=1.1.3 664, and thus decodes Kafka Message 665 using FM Decoder for processing data using one or more Management Tags, e.g., Encoding Schema Version 1.1.3 684.

FM-MS1 630 and FM-MS2 650 prepare the one or more Management Tags including the one or more FM Encoding Type or Schema Version Tags based on the one or more Encoding Type or Schema Source Files and the encoding used. FM-MS1 630 and FM-MS2 650 encode the FM data using the corresponding one or more FM Encoding Type or Schema identified by the one or more FM Encoding Type or Schema Version Tags. FM-MS1 630 and FM-MS2 650 embed the one or more Management Tags including the one or more FM Encoding Type or Schema Version Tags in the Kafka Message Headers and embed the encoded FM data in the body of the Kafka Messages 660. FM-MS1 630 and FM-MS2 650 then send the Kafka Messages 660 to the Northbound Management System 670. The Northbound Management System 670 reads the one or more Management Tags including the one or more FM Encoding Type or Schema Version Tags from the Kafka Message Headers. The Northbound Management System 670 then decodes the FM data in the Kafka Messages 660 using a decoder corresponding to the one or more FM Encoding Type or Schema identified by the one or more FM Encoding Type or Schema Version Tags from the Kafka Message Headers of the Kafka Messages 660. FM-MS1 630 and FM-MS2 650 then process the next FM data for the next Kafka Message 660 sent to the Northbound Management System 670.

The Additional Management Tags are able to be added in each of PM/FM Kafka Message 660 to help the Northbound Management System (NBMS) 670 make decisions or to handle the data with priority etc. before the NBMS 670 even begins decoding the actual PM/FM data. Examples of Additional Management Tags include one or more of a Base Station Identifier (ID) Tag, an Event Timestamp Tag, or a ROP (Reporting Output Period) Timestamp Tag.

For example, a Base Station Identifier (ID) Tag, such as for gNB/eNB ID, is able to be included in the Kafka Message Header to help monitor data from a particular base station, e.g., high priority cell sites, such as VIP areas, etc. A Base Station Identifier (ID) Tag is able to include one or more of gNB=<gNB id> or eNB=<id>. An Event Timestamp Tag for FM data is able to be included in the Kafka Message Header for sharing by the gNB/eNB with the NBMS 670 to convey a sense of priority for processing the events, e.g., in response to the NBMS 670 processing more than one Kafka data message. An Event Timestamp Tag is able to include Timestamp=<timestamp>. A ROP (Reporting Output Period) Timestamp Tag for FM data is able to be included in the Kafka Message Header to identify a begin end timestamp of the measurement period. The ROP Timestamp Tag helps the FM engine of the NBMS 670 know the FM data's timestamp, which is located in the body of the Kafka message. A ROP Timestamp Tag is able to include ROP=<timestamp>.

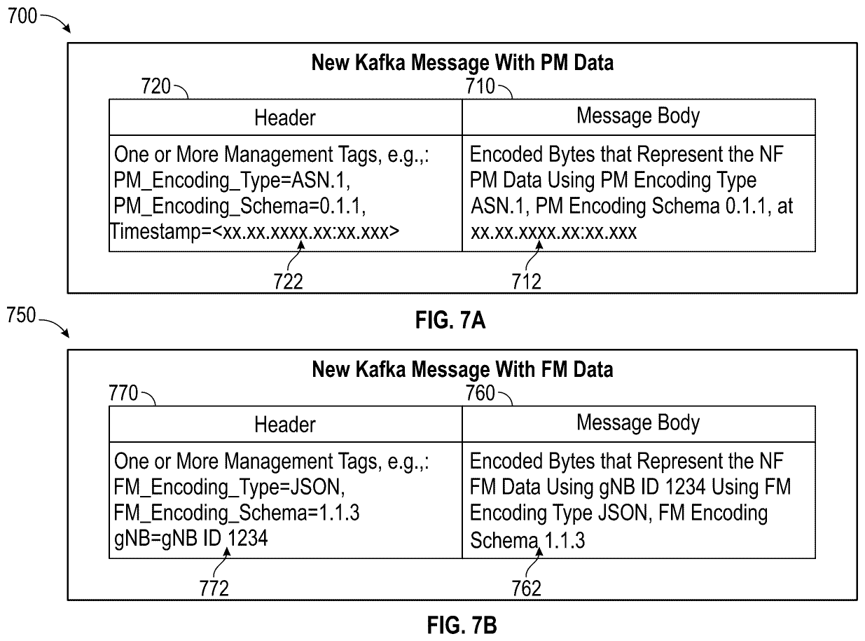

FIGS. 7A-B illustrate Kafka Messages 700, 750 with Header Schema Identification according to at least one embodiment.

In FIG. 7A, Kafka Message 700 includes PM data. Kafka Message 700 includes the Message Body 710 and Header 720. Message Body 710 is shown including encoded bytes 712 using, for example, PM Encoding Type Abstract Syntax Notation One (ASN.1), and PM Encoding Schema 0.1.1 The data in the Message Body 710 is also able to include a timestamp, xx.xx.xxxxxx:xx:xxx. Encoded data 712 is sent by a PM MS using PM Encoding Type ASN.1, and PM Encoding Schema 0.1.1 to the Northbound Management System over the Kafka transport. The Kafka Message 700 includes the encoded data in the Message Body 710, but the Kafka Message 700 also has a header capability that is now used for schema version identification and management. The Kafka Header 720 is a generic header mechanism. PM Microservice of NFs add one or more Management Tags 722 to Header 720, e.g., one or more Encoding Type or Schema Version or the Encoding Schema Version Tags. In FIG. 7A, Header 720 includes identification of or more Management one Tags, e.g., PM_Encoding_Type=ASN.1, PM_Encoding_Schema=0.1.1, or Additional Management Tags such as a Timestamp 722. The one or more Management Tags 722 including the one or more PM Encoding Type or Encoding Schema Version Tags are embedded in the Kafka Message Header 720 along with any Additional Management Tags, and the encoded PM data 712 is embedded in the Kafka Message Body 710.

A Northbound Management System includes different decoders for working with different versions of the software of the NFs. Northbound Management System reads the one or more Management Tags 722 in Header 720, and then based on the Management Tags 722 in Header 720, Northbound Management System determines how to process the data and which decoder to use for decoding the encoded data in the Message Body 710. The Management Tags 722 embedded in Header 720 decouple the software version or the microservice software version with the PM schema.

In FIG. 7B, Kafka Message 750 includes FM data. Kafka Message 750 includes the Message Body 760 and Header 770. Message Body 760 is shown including encoded bytes 762 using, for example, one or more of FM Encoding Type JSON or FM Encoding Schema 1.1.3. The data in the Message Body 760 is also able to include identification of the base station, e.g., gNB ID 1234. Encoded data 762 is sent by an FM MS using, for example, one or more of FM Encoding Type JSON or FM Encoding Schema 1.1.3 to the Northbound Management System over the Kafka transport. FM Microservice of NFs add one or more Management Tags 762 to Header 720 to identify the one or more FM Encoding Type, or the Schema Version or Encoding Schema Version that is being used, along with Additional Management Tags, such as the base station identifier, GNB ID 1234. In FIG. 7B, Header 770 includes identification of FM_Encoding_Type=JSON, and FM_Encoding_Schema=1.1.3 772. The one or more FM Encoding Type or Schema Version Tags 772 are embedded in the Kafka Message Header 770 along with any Additional Management Tags. The encoded FM data 762 is embedded in the Kafka Message Body 760.

The Kafka Message Headers 720, 770 are embedded with strings providing “<key>=<value>” type content. Thus, the Kafka Message Headers 720, 770 provide the Northbound Management System with the one or more Management Tags including one or more PM/FM Encoding Type or Schema Version so that PM/FM data 712, 762 is able to be decoded by the Northbound Management System. Thus, the Kafka Message Headers 720, 770 are able to identify the one or more Management Tags that a decoder is able to use, such as:

$$PM\_ENCODING \_TYPE = A S N \text{.1} , PM\_ENCODING \_SCHEMA = 0.1 \text{.1} ;$$

$$PM\_ENCODING \_TYPE = PROTO , PM\_ENCODING \_SCHEMA = 0.1 \text{.0} ;$$

$$PM\_ENCODING \_TYPE = A S N \text{.1} , PM\_ENCODING \_SCHEMA = 0.1 \text{.0} ;$$

$$FM\_ENCODING \_TYPE = JSON , FM\_ENCODING \_SCHEMA = 0.1 \text{.0} ; and$$

$$FM\_ENCODING \_TYPE = XML , FM\_ENCODING \_SCHEMA = 0 \text{.1} \text{.0} ; etc .$$

A Management tag conveys gNB/eNB NFs are capable of producing the PM/FM data in different formats (XML/ASN.1/JSON/PROTO, etc.) and different versions of schema for each of the format (0.1.0/0.1.1/1.0.1, etc.). Depending on usage more tags can be added to clarify the PM/FM data content to the Northbound Management System (NBMS). Some tags will be directly relevant for the “decode” process, whereas some Management Tags are able to be used by the NBMS in other processes/stages etc.

However, other types of Encoding Types and Schema are able to be included in the Kafka Message Headers 720, 770 as software versions used by the NFs. Thus, the one or more PM Encoding Type or Schema Version Tags 722 and the one or more FM Encoding Type or Schema Version Tags 772 that are included in Kafka Message Headers 720, 770, respectively, enable a Northbound Management System to identify the encoding type and schema used by microservices in a 5G O-RAN system. However, the one or more PM Encoding Type or Schema Version Tags 722 and the one or more FM Encoding Type or Schema Version Tags 772 that are included in Kafka Message Headers 720, 770, respectively, are equally applicable to LTE (4G) O-RAN systems.

In addition, Additional Management Tags are also able to be added in each PM/FM Kafka Message to help the NBMS make decisions or to handle the data with priority etc. before the NBMS even begins decoding the actual PM/FM data. Examples of Additional Management Tags include one or more of a Base Station Identifier (ID) Tag, an Event Timestamp Tag, or a ROP (Reporting Output Period) Timestamp Tag.

For example, a Base Station Identifier (ID) Tag, such as for gNB/eNB ID, is able to be included in the Kafka Message Header to help monitor data from a particular base station, e.g., high priority cell sites, such as VIP areas, etc. A Base Station Identifier (ID) Tag is able to include one or more of gNB=<gNB id> or eNB=<id>. An Event Timestamp Tag is able to be included in the Kafka Message Header for sharing by the gNB/eNB with the NBMS to convey a sense of priority for processing the events, e.g., in response to the NBMS processing more than one Kafka data message. An Event Timestamp Tag is able to include Timestamp=<timestamp>. A ROP (Reporting Output Period) Timestamp Tag for PM data is able to be included in the Kafka Message Header to identify a begin end timestamp of the measurement period. The ROP Timestamp Tag helps the NBMS know the PM data's timestamp, which is located in the body of the Kafka message. A ROP Timestamp Tag is able to include ROP=<timestamp>.

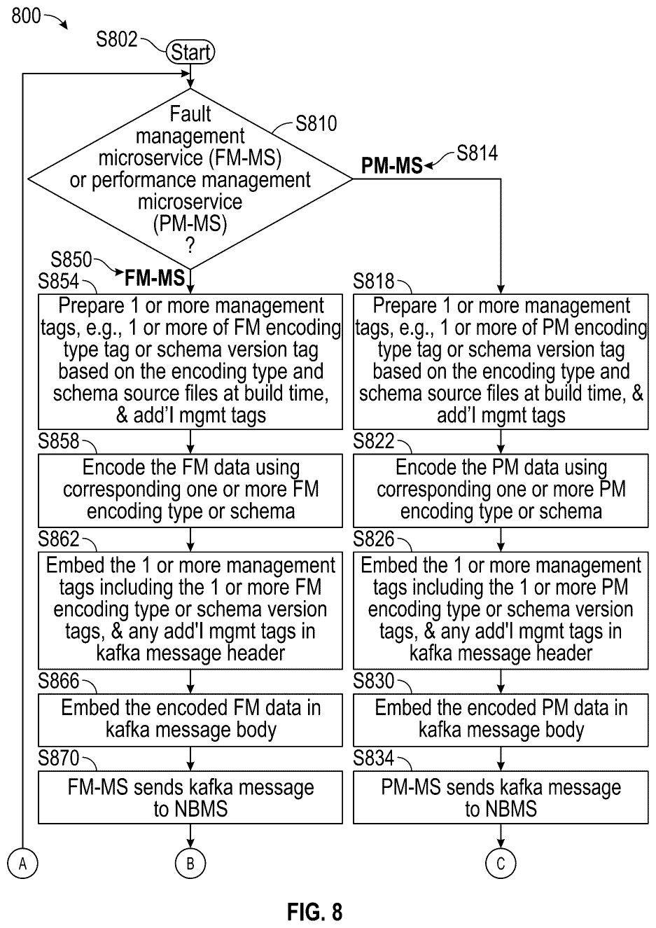

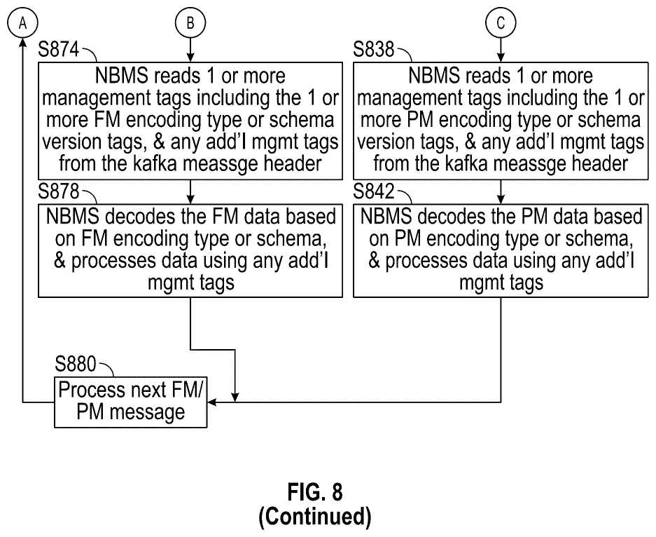

FIG. 8 is a flowchart 800 of a method for Kafka header based schema version management according to at least one embodiment.

In FIG. 8, the processor starts S802, and a determination is made whether a Fault Management Microservice (FM-MS) or a Performance Management Microservice (PM-MS) is involved S810.

In response to PM MS being involved S814, one or more PM Management Tags are prepared, e.g., one or more of PM Encoding Type Tag or Schema Version Tag based on the Encoding Type and Schema Source Files at build time, as well as any Additional Management Tags S818. Referring to FIG. 5, PM-MS1 530 and PM-MS2 550 prepare the one or more Management Tags including the one or more PM Encoding Type or Schema Version Tags based on the one or more Encoding Type or Schema Source Files and the encoding used.

The PM data is encoded using a corresponding one or more PM Encoding Type or Schema S822. Referring to FIG. 5, PM-MS1 530 and PM-MS2 550 encode the PM data using the corresponding one or more PM Encoding Type or Schema identified by the one or more PM Encoding Type or Schema Version Tags.

The one or more Management Tags including the one or more PM Encoding Type or Schema Version Tags, and any Additional Management Tags are embedded in the Kafka Message Header S826. Referring to FIG. 5, PM-MS1 530 and PM-MS2 550 embed the one or more Management Tags including the one or more PM Encoding Type or Schema Version Tags in the Kafka Message Headers.

The encoded PM data is embedded in the body of the Kafka Message S830. Referring to FIG. 5, PM-MS1 530 and PM-MS2 550 embed the encoded PM data in the body of the Kafka Messages 560.

The PM-MS sends the Kafka Message to the Northbound Management System S834.

Referring to FIG. 5, PM-MS1 530 and PM-MS2 550 then send the Kafka Messages 560 to the Northbound Management System 570.

The Northbound Management System reads the one or more Management Tags including the one or more PM Encoding Type or Schema Version Tags, and any Additional Management Tags From the Kafka Message Header S838. Referring to FIG. 5, the Northbound Management System 570 reads the one or more Management Tags including the one or more PM Encoding Type or Schema Version Tags from the Kafka Message Headers.

The Northbound Management System decodes the PM data based on the one or more PM Encoding Type or Schema Tags identified in the Header, and processes any Additional Management Tags in the Header S842. Referring to FIG. 5, the Northbound Management System 570 then processes the PM data using any Additional Management Tags, and decodes the PM data in the Kafka Messages 560 using a decoder corresponding to the one or more PM Encoding Type or Schema identified by the one or more PM Encoding Type or Schema Version Tags from the Kafka Message Headers of the Kafka Messages 560.

The process loops back to process the next FM/PM Message S880. Referring to FIG. 5, PM-MS1 530 and PM-MS2 550 then process the next PM data for the next Kafka Message 560 sent to the Northbound Management System 570.

In response to FM MS being involved S850, one or more FM Management Tags are prepared, e.g., one or more of FM Encoding Type Tag or Schema Version Tag based on the Encoding Type and Schema Source Files at build time, as well as any Additional Management Tags S854. Referring to FIG. 6, FM-MS1 630 and FM-MS2 650 prepare the one or more Management Tags including the one or more FM Encoding Type or Schema Version Tags based on the one or more Encoding Type or Schema Source Files and the encoding used.

The FM data is encoded using a corresponding one or more FM Encoding Type or Schema S858. Referring to FIG. 6, FM-MS1 630 and FM-MS2 650 encode the FM data using the corresponding one or more FM Encoding Type or Schema identified by the one or more FM Encoding Type or Schema Version Tags.

The one or more Management Tags including the one or more FM Encoding Type or Schema Version Tags, and any Additional Management Tags are embedded in the Kafka Message Header S862. Referring to FIG. 6, FM-MS1 630 and FM-MS2 650 embed the one or more Management Tags including the one or more FM Encoding Type or Schema Version Tags in the Kafka Message Headers.

The encoded FM data is embedded in the body of the Kafka Message S866. Referring to FIG. 6, FM-MS1 630 and FM-MS2 650 embed the encoded FM data in the body of the Kafka Messages 660.

The FM-MS sends the Kafka Message to the Northbound Management System S870. Referring to FIG. 6, FM-MS1 630 and FM-MS2 650 then send the Kafka Messages 660 to the Northbound Management System 670.

The Northbound Management System reads the one or more Management Tags including the one or more FM Encoding Type or Schema Version Tags, and any Additional Management Tags From the Kafka Message Header of the Kafka Message S874. Referring to FIG. 6, the Northbound Management System 670 reads the one or more Management Tags including the one or more FM Encoding Type or Schema Version Tags from the Kafka Message Headers.

The Northbound Management System decodes the FM data based on the one or more FM Encoding Type or Schema, and processes data using any Additional Management Tags identified in the Header S878. Referring to FIG. 6, the Northbound Management System 670 then processes the FM data using any Additional Management Tags, and decodes the FM data in the Kafka Messages 660 using a decoder corresponding to the one or more FM Encoding Type or Schema identified by the one or more FM Encoding Type or Schema Version Tags from the Kafka Message Headers of the Kafka Messages 660.

The process loops back to process the next FM/PM Message S880. Referring to FIG. 6, FM-MS1 630 and FM-MS2 650 then process the next FM data for the next Kafka Message 660 sent to the Northbound Management System 670.

In at least one embodiment, Kafka header based Schema management is provided. A microservice prepares one or more Management Tags including one or more Encoding Type or Schema Version Tags based on one or more Encoding Type or Schema Source Files used by the microservice. In at least one embodiment, the microservice is a Performance Management (PM) Microservice. In at least one embodiment, the microservice is a Fault Management (FM) Microservice. The microservice encodes data using one or more Encoding Type or Schema Version identified by the one or more Encoding Type or Schema Version Tags to produce encoded data. The microservice embeds the one or more Encoding Type or Schema Version Tags in a Header of a Kafka Message and embeds the encoded data in a Message Body of the Kafka Message. The microservice sends the Kafka Message to a Northbound Management System for decoding based on the one or more Encoding Type or Schema Version Tags in the Header of the Kafka Message. The Northbound Management System reads the one or more Encoding Type or Schema Version Tags From the Kafka Message Header of the Kafka Message and decodes the encoded data in the Message Body of the Kafka Message using a corresponding one or more Encoding Type or Schema Version identified in the Header. A microservice is also able to prepare Additional Management Tags that are able to be added in each PM/FM Kafka Message to help the NBMS make decisions or to handle the data with priority etc. before the NBMS even begins decoding the actual PM/FM data. Examples of Additional Management Tags include one or more of a Base Station Identifier (ID) Tag, an Event Timestamp Tag, or a ROP (Reporting Output Period) Timestamp Tag. For example, a Base Station Identifier (ID) Tag, such as for gNB/eNB ID, is able to be included in the Kafka Message Header to help monitor data from a particular base station, e.g., high priority cell sites, such as VIP areas, etc. A Base Station Identifier (ID) Tag is able to include one or more of gNB=<gNB id> or eNB=<id>. An Event Timestamp Tag is able to be included in the Kafka Message Header for sharing by the gNB/eNB with the NBMS to convey a sense of priority for processing the events, e.g., in response to the NBMS processing more than one Kafka data message. An Event Timestamp Tag is able to include Timestamp=<timestamp>. A ROP (Reporting Output Period) Timestamp Tag is able to be included in the Kafka Message Header to identify a begin end timestamp of the measurement period. The ROP Timestamp Tag helps the PM engine of the NBMS know the data's timestamp, which is located in the body of the Kafka message. A ROP Timestamp Tag is able to include ROP=<timestamp>.

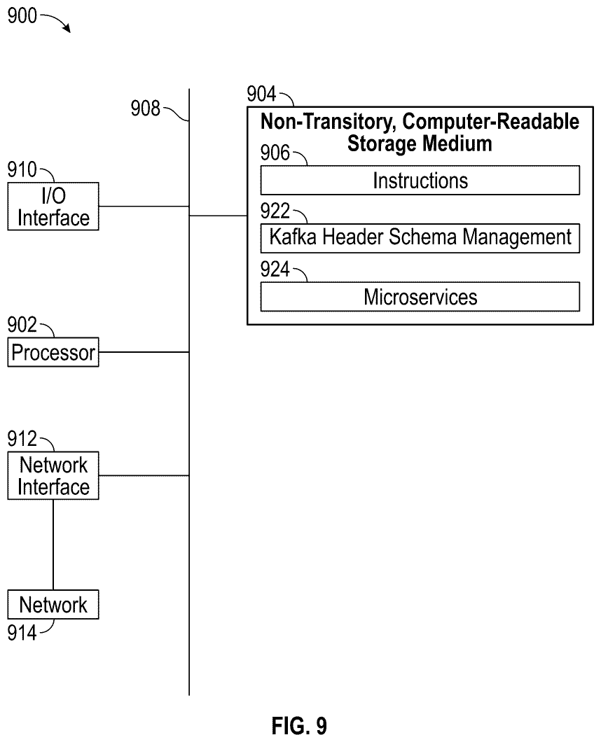

FIG. 9 is a high-level functional block diagram of a processor-based system 900 according to at least one embodiment.

In at least one embodiment, processing circuitry 900 provides Kafka header based schema version management in encoding and decoding Performance Management (PM)/Fault Management (FM) data. Processing circuitry 900 implements Kafka header based schema version management using Processor 902. Processing circuitry 900 also includes a Non-Transitory, Computer-Readable Storage Medium 904 that is used to implement Kafka header based schema version management. Non-Transitory, Computer-Readable Storage Medium 904, amongst other things, is encoded with, i.e., stores, Instructions 906, i.e., computer program code, that are executed by Processor 902 to cause Processor 902 to perform operations for Kafka header based schema version management. Execution of Instructions 906 by Processor 902 represents (at least in part) an application which implements at least a portion of the methods described herein in accordance with one or more embodiments (hereinafter, the noted processes and/or methods).

Processor 902 is electrically coupled to Non-Transitory, Computer-Readable Storage Medium 904 via a Bus 908. Processor 902 is electrically coupled to an Input/Output (I/O) Interface 910 by Bus 908. A Network Interface 912 is also electrically connected to Processor 902 via Bus 908. Network Interface 912 is connected to a Network 914, so that Processor 902 and Non-Transitory, Computer-Readable Storage Medium 904 connect to external elements via Network 914. Processor 902 is configured to execute Instructions 906 encoded in Non-Transitory, Computer-Readable Storage Medium 904 to cause processing circuitry 900 to be usable for performing at least a portion of the processes and/or methods. In one or more embodiments, Processor 902 is a Central Processing Unit (CPU), a multi-processor, a distributed processing system, an Application Specific Integrated Circuit (ASIC), and/or a suitable processing unit.

Processing circuitry 900 includes I/O Interface 910. I/O interface 910 is coupled to external circuitry. In one or more embodiments, I/O Interface 910 includes a keyboard, keypad, mouse, trackball, trackpad, touchscreen, and/or cursor direction keys for communicating information and commands to Processor 902.

Processing circuitry 900 also includes Network Interface 912 coupled to Processor 902. Network Interface 912 allows processing circuitry 900 to communicate with Network 914, to which one or more other computer systems are connected. Network Interface 912 includes wireless network interfaces such as Bluetooth, Wi-Fi, Worldwide Interoperability for Microwave Access (WiMAX), General Packet Radio Service (GPRS), or Wideband Code Division Multiple Access (WCDMA); or wired network interfaces such as Ethernet, Universal Serial Bus (USB), or Institute of Electrical and Electronics Engineers (IEEE) 864.

Processing circuitry 900 is configured to receive information through I/O Interface 910. The information received through I/O Interface 910 includes one or more of instructions, data, design rules, libraries of cells, and/or other parameters for processing by Processor 902. The information is transferred to Processor 902 via Bus 908.

In one or more embodiments, one or more Non-Transitory, Computer-Readable Storage Medium 904 having stored thereon Instructions 906 (in compressed or uncompressed form) that may be used to program a computer, processor, or other electronic device) to perform processes or methods described herein. The one or more Non-Transitory, Computer-Readable Storage Medium 904 include one or more of an electronic storage medium, a magnetic storage medium, an optical storage medium, a quantum storage medium, or the like.

For example, the Non-Transitory, Computer-Readable Storage Medium 904 may include, but are not limited to, hard drives, floppy diskettes, optical disks, read-only memories (ROMs), random access memories (RAMs), erasable programmable ROMs (EPROMs), electrically erasable programmable ROMs (EEPROMs), flash memory, magnetic or optical cards, solid-state memory devices, or other types of physical media suitable for storing electronic instructions. In one or more embodiments using optical disks, the one or more Non-Transitory Computer-Readable Storage Media 904 includes a Compact Disk-Read Only Memory (CD-ROM), a Compact Disk-Read/Write (CD-R/W), and/or a Digital Video Disc (DVD).

In one or more embodiments, Non-Transitory, Computer-Readable Storage Medium 904 stores Instructions 906 configured to cause Processor 902 to perform at least a portion of the processes and/or methods for Kafka header based schema management. In one or more embodiments, Non-Transitory, Computer-Readable Storage Medium 904 also stores information, such as algorithm which facilitates performing at least a portion of the processes and/or methods for Kafka header based schema management.

Accordingly, in at least one embodiment, Processor 902 executes Instructions 906 stored on the one or more Non-Transitory, Computer-Readable Storage Medium 904 to implement Kafka Header Schema Encoding 922. Processor 902 implements a microservice that prepares one or more Management Tags including gone or more Encoding Type or Schema Version Tags identifying the one or more Encoding Type or Schema Version for a Kafka Message. The microservice encodes or decodes the Kafka Message. Processor 902 implements Microservices 924 that prepare the Management Tags including the one or more PM/FM Encoding Type or Schema Version Tags based on the one or more Encoding Type or Schema Source Files and the encoding used. Microservices 924 encode the PM/FM data using the corresponding one or more PM/FM Encoding Type or Schema Version identified by the one or more PM/FM Encoding Type or Schema Version Tags. Microservices 924 embed the one or more PM/FM Encoding Type or Schema Version Tags in the Kafka Message Headers and embed the encoded PM/FM data in the body of the Kafka Messages. Microservices 924 then send the Kafka Messages to the Northbound Management System. Microservices 924 then process the next PM/FM data for the next Kafka Message sent to the Northbound Management System. Without the one or more PM/FM Encoding Type or Schema Version Tags being provided in the Kafka Message Headers, the Northbound Management System does not know how to decode the encoded PM/FM data. Processor 902 is also able to embed Management Tags in the Kafka Message Header. Management Tags are also able to include Additional Management Tags that are able to be added in each PM/FM Kafka Message to help the NBMS make decisions or to handle the data with priority etc. before the NBMS even begins decoding the actual PM/FM data. Examples of Additional Management Tags include one or more of a Base Station Identifier (ID) Tag, an Event Timestamp Tag, or a ROP (Reporting Output Period) Timestamp Tag. For example, a Base Station Identifier (ID) Tag, such as for gNB/eNB ID, is able to be included in the Kafka Message Header to help monitor data from a particular base station, e.g., high priority cell sites, such as VIP areas, etc. A Base Station Identifier (ID) Tag is able to include one or more of gNB=<gNB id> or eNB=<id>. An Event Timestamp Tag for data is able to be included in the Kafka Message Header for sharing by the gNB/eNB with the NBMS to convey a sense of priority for processing the events, e.g., in response to the NBMS processing more than one Kafka data message. An Event Timestamp Tag is able to include Timestamp=<timestamp>. A ROP (Reporting Output Period) Timestamp Tag for data is able to be included in the Kafka Message Header to identify a begin end timestamp of the measurement period. The ROP Timestamp Tag helps the PM engine of the NBMS know the data's timestamp, which is located in the body of the Kafka message. A ROP Timestamp Tag is able to include ROP=<timestamp>.

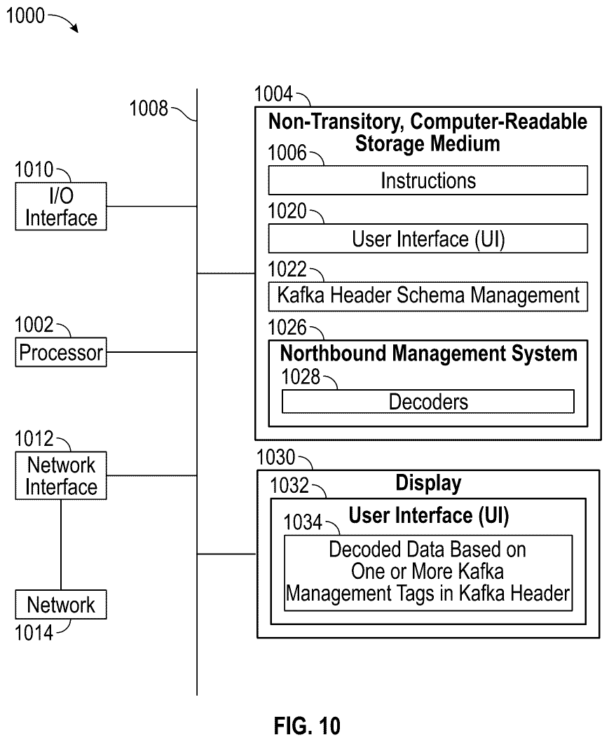

FIG. 10 is a high-level functional block diagram of a processor-based system 1000 according to at least one embodiment.

In at least one embodiment, processing circuitry 1000 provides Kafka header based schema management. Processing circuitry 1000 implements Kafka header based schema management using Processor 1002. Processing circuitry 1000 also includes a Non-Transitory, Computer-Readable Storage Medium 1004 that is used to implement Kafka header based schema management. Non-Transitory, Computer-Readable Storage Medium 1004, amongst other things, is encoded with, i.e., stores, Instructions 1006, i.e., computer program code, that are executed by Processor 1002 causes Processor 1002 to perform operations for Kafka header based schema version management. Execution of Instructions 1006 by Processor 1002 represents (at least in part) an application which implements at least a portion of the methods described herein in accordance with one or more embodiments (hereinafter, the noted processes and/or methods).

Processor 1002 is electrically coupled to Non-Transitory, Computer-Readable Storage Medium 1004 via a Bus 1008. Processor 1002 is electrically coupled to an Input/Output (I/O) Interface 1010 by Bus 1008. A Network Interface 1012 is also electrically connected to Processor 1002 via Bus 1008. Network Interface 1012 is connected to a Network 1014, so that Processor 1002 and Non-Transitory, Computer-Readable Storage Medium 1004 connect to external elements via Network 1014. Processor 1002 is configured to execute Instructions 1006 encoded in Non-Transitory, Computer-Readable Storage Medium 1004 to cause processing circuitry 1000 to be usable for performing at least a portion of the processes and/or methods. In one or more embodiments, Processor 1002 is a Central Processing Unit (CPU), a multi-processor, a distributed processing system, an Application Specific Integrated Circuit (ASIC), and/or a suitable processing unit.

Processing circuitry 1000 includes I/O Interface 1010. I/O interface 1010 is coupled to external circuitry. In one or more embodiments, I/O Interface 1010 includes a keyboard, keypad, mouse, trackball, trackpad, touchscreen, and/or cursor direction keys for communicating information and commands to Processor 1002.

Processing circuitry 1000 also includes Network Interface 1012 coupled to Processor 1002. Network Interface 1012 allows processing circuitry 1000 to communicate with Network 1014, to which one or more other computer systems are connected. Network Interface 1012 includes wireless network interfaces such as Bluetooth, Wi-Fi, Worldwide Interoperability for Microwave Access (WiMAX), General Packet Radio Service (GPRS), or Wideband Code Division Multiple Access (WCDMA); or wired network interfaces such as Ethernet, Universal Serial Bus (USB), or Institute of Electrical and Electronics Engineers (IEEE) 864.

Processing circuitry 1000 is configured to receive information through I/O Interface 1010. The information received through I/O Interface 1010 includes one or more of instructions, data, design rules, libraries of cells, and/or other parameters for processing by Processor 1002. The information is transferred to Processor 1002 via Bus 1008. Processing circuitry 1000 is configured to receive information related to a User Interface (UI) through I/O Interface 1010. The information is stored in Non-Transitory, Computer-Readable Storage Medium 1004 as UI 1020.

In one or more embodiments, one or more Non-Transitory, Computer-Readable Storage Medium 1004 having stored thereon Instructions 1006 (in compressed or uncompressed form) that may be used to program a computer, processor, or other electronic device) to perform processes or methods described herein. The one or more Non-Transitory, Computer-Readable Storage Medium 1004 include one or more of an electronic storage medium, a magnetic storage medium, an optical storage medium, a quantum storage medium, or the like.

For example, the Non-Transitory, Computer-Readable Storage Medium 1004 may include, but are not limited to, hard drives, floppy diskettes, optical disks, read-only memories (ROMs), random access memories (RAMs), erasable programmable ROMs (EPROMs), electrically erasable programmable ROMs (EEPROMs), flash memory, magnetic or optical cards, solid-state memory devices, or other types of physical media suitable for storing electronic instructions. In one or more embodiments using optical disks, the one or more Non-Transitory Computer-Readable Storage Media 1004 includes a Compact Disk-Read Only Memory (CD-ROM), a Compact Disk-Read/Write (CD-R/W), and/or a Digital Video Disc (DVD).

In one or more embodiments, Non-Transitory, Computer-Readable Storage Medium 1004 stores Instructions 1006 configured to cause Processor 1002 to perform at least a portion of the processes and/or methods for Kafka header based schema management. In one or more embodiments, Non-Transitory, Computer-Readable Storage Medium 1004 also stores information, such as algorithm which facilitates performing at least a portion of the processes and/or methods for Kafka header based schema management.

Processor 1002 executes Instructions 1006 stored on the one or more Non-Transitory, Computer-Readable Storage Medium 1004 to implement Kafka Header Schema Encoding 1022, and to implement Northbound Management System 1026. Processor 1002 implements Decoders 1028 on Northbound Management System 1026 that are able to decode data based on reading one or more PM/FM Encoding Type or Schema Version Tags from the Kafka Message Headers. The Northbound Management System 1026 decodes the PM/FM data in the Kafka Messages 660 using one or more of Decoders 1028 that corresponds to the one or more PM/FM Encoding Type or Schema Version identified by the one or more PM/FM Encoding Type or Schema Version Tags obtained from the Kafka Message Headers of the Kafka Messages. Northbound Management System 1026 then processes the next PM/FM data for the next Kafka Message received from microservices of one or more gNB NFs. The one or more PM/FM Encoding Type or Schema Version Tags provided in the Kafka Message Headers enable the Northbound Management System 1026 to determine how to decode the encoded PM/FM data. Display Device 1030 presents a User Interface (UI) 1032. Data decoded using the Kafka Header Schema Encoding based on a Header Tag identifying the one or more Encoding Type or Schema Version for decoding 1034 is displayed in UI 1032. The Northbound Management System 1026 is also able to process Additional Management Tags that Processor 902 is also able to embed in the Kafka Message Header. Additional Management Tags that are able to be added in each PM/FM Kafka Message to help the NBMS make decisions or to handle the data with priority etc. before the NBMS even begins decoding the actual PM/FM data. Examples of Additional Management Tags include one or more of a Base Station Identifier (ID) Tag, an Event Timestamp Tag, or a ROP (Reporting Output Period) Timestamp Tag. For example, a Base Station Identifier (ID) Tag, such as for gNB/eNB ID, is able to be included in the Kafka Message Header to help monitor data from a particular base station, e.g., high priority cell sites, such as VIP areas, etc. A Base Station Identifier (ID) Tag is able to include one or more of gNB=<gNB id> or eNB=<id>. An Event Timestamp Tag for data is able to be included in the Kafka Message Header for sharing by the gNB/eNB with the NBMS to convey a sense of priority for processing the events, e.g., in response to the NBMS processing more than one Kafka data message. An Event Timestamp Tag is able to include Timestamp=<timestamp>. A ROP (Reporting Output Period) Timestamp Tag for data is able to be included in the Kafka Message Header to identify a begin end timestamp of the measurement period. The ROP Timestamp Tag helps the PM engine of the NBMS know the PM data's timestamp, which is located in the body of the Kafka message. A ROP Timestamp Tag is able to include ROP=<timestamp>.

PM/FM data is associated with corresponding one or more PM/FM Encoding Type or Schema Version Tags which can be used by a Northbound Management System to decode the respective data. Embodiments described herein provide a method that provides one or more advantages. For example, the Kafka Header Based one or more Encoding Type or Schema Version Management according to at least one embodiment has the ability to manage different versions of microservice software and is scalable because different microservices are able to run with the different one or more PM Encoding Type or Schema, one or more FM Encoding Type or Schema, etc. The one or more PM/FM Encoding Type or Schema Version Tags are embedded in the Kafka Message Header along with the encoded PM/FM data in the Kafka message body. Kafka header based encoding type and schema version management is microservice oriented and does not depend on the software version of the gNB NFs. Instead the Performance Management Microservice (PM MS)/Fault Management Microservice (FM MS) self publishes its Encoding Type and Schema to the Northbound Management System. The implementation and use of decode logic at the Northbound Management System is based on a simple Kafka header check. The Northbound Management System is able to decode with the decoder corresponding to the Encoding Type and Schema Version identified by the Tags in the Kafka Message Header. The Northbound Management System is able to be a simpler implementation that does not rely on complicated logic of handling the inventory, and the schema version logic, etc. The process involves a simple header check, and then logic for choosing the decoder according to the Tags in the Kafka Message Header. The Northbound Management System (NBMS) 1026 is also able to process Additional Management Tags to help the NBMS make decisions or to handle the data with priority etc. before the NBMS even begins decoding the actual PM/FM data. Examples of Additional Management Tags include one or more of a Base Station Identifier (ID) Tag, an Event Timestamp Tag, or a ROP (Reporting Output Period) Timestamp Tag. For example, a Base Station Identifier (ID) Tag, such as for gNB/eNB ID, is able to be included in the Kafka Message Header to help monitor data from a particular base station, e.g., high priority cell sites, such as VIP areas, etc. A Base Station Identifier (ID) Tag is able to include one or more of gNB=<gNB id> or eNB=<id>. An Event Timestamp Tag for data is able to be included in the Kafka Message Header for sharing by the gNB/eNB with the NBMS to convey a sense of priority for processing the events, e.g., in response to the NBMS processing more than one Kafka data message. An Event Timestamp Tag is able to include Timestamp=<timestamp>. A ROP (Reporting Output Period) Timestamp Tag for data is able to be included in the Kafka Message Header to identify a begin end timestamp of the measurement period. The ROP Timestamp Tag helps the NBMS know the data's timestamp, which is located in the body of the Kafka message. A ROP Timestamp Tag is able to include ROP=<timestamp>.

In a method for providing Kafka header based schema version management according to at least one embodiment, the method includes preparing, by a microservice, one or more Management Tags including one or more Encoding Type or Schema Version Tags based on one or more Encoding Type or Schema Source Files used by the microservice, encoding, by the microservice, data using one or more Encoding Type or Schema Version identified by the one or more Encoding Type or Schema Version Tags to produce encoded data, embedding, by the microservice, the one or more Encoding Type or Schema Version Tags in a Header of a Kafka Message, embedding, by the microservice, the encoded data in the Message Body of the Kafka Message, and sending the Kafka Message to a Northbound Management System for decoding based on the one or more Encoding Type or Schema Version Tags in the Header of the Kafka Message.

In a method according to at least one embodiment, the preparing, by the microservice, the one or more Management Tags further includes preparing Additional Management Tags, wherein the Additional Management Tags include one or more a Base Station Identifier Tag, an Event Timestamp Tag, or a Reporting Out Period (ROP) Timestamp Tag.

In a method according to at least one embodiment, the preparing, by the microservice, the one or more Encoding Type or Schema Version further includes preparing, by a Fault Management (FM) Microservice, one or more FM Encoding Type or Schema Version Tags, the encoding, by the microservice, data using the one or more Encoding Type or Schema Version identified by the one or more Encoding Type or Schema Version Tags to produce encoded data further includes encoding the data using the one or more Encoding Type or Schema Version identified by the one or more FM Encoding Type or Schema Version Tags to produce encoded FM data, the embedding the one or more Encoding Type or Schema Version Tags in the Header of a FM Kafka Message further includes embedding the one or more FM Encoding Type or Schema Version Tags in the Header of the FM Kafka Message, the embedding the encoded data in the Message Body of the Kafka Message further includes embedding the encoded FM data in the Message Body of the FM Kafka Message, and the sending the Kafka Message to the Northbound Management System for decoding based on the one or more Encoding Type or Schema Version Tags in the Header of the Kafka Message further includes sending the FM Kafka Message to the Northbound Management System for decoding based on the one or more FM Encoding Type or Schema Version Tags in the Header of the FM Kafka Message.

In a method according to at least one embodiment, the embedding the one or more FM Encoding Type or Schema Version Tags in the Header of the FM Kafka Message further includes embedding the one or more FM Encoding Type or Schema Version Tags in the Header of the FM Kafka Message useable for identifying an FM decoder configured for decoding encoded FM data using the one or more FM Encoding Type or Schema Version identified by the one or more FM Encoding Type or Schema Version Tags.

In a method according to at least one embodiment, the preparing, by the microservice, the one or more Encoding Type or Schema Version Tags further includes preparing, by a Performance Management (PM) Microservice, one or more PM Encoding Type or Schema Version Tags.

In a method according to at least one embodiment, the encoding the data using the one or more Encoding Type or Schema Version identified by the one or more Encoding Type or Schema Version Tags to produce encoded data further includes encoding the data using the one or more Encoding Type or Schema Version identified by the one or more PM Encoding Type or Schema Version Tags to produce encoded PM data, the embedding the one or more Encoding Type or Schema Version Tags in the Header of the Kafka Message further includes embedding the one or more PM Encoding Type or Schema Version Tags in the Header of the PM Kafka Message, the embedding the encoded data in the Message Body of the Kafka Message further includes embedding the encoded PM data in the Message Body of the PM Kafka Message, and the sending the Kafka Message to the Northbound Management System for decoding based on the one or more Encoding Type or Schema Version Tags in the Header of the Kafka Message further includes sending the PM Kafka Message to the Northbound Management System for decoding based on the one or more PM Encoding Type or Schema Version Tags in the Header of the PM Kafka Message.

In a method according to at least one embodiment, the embedding the one or more PM Encoding Type or Schema Version Tags in the Header of the PM Kafka Message further includes embedding the one or more PM Encoding Type or Schema Version Tags in the Header of the PM Kafka Message useable for identifying a PM decoder configured for decoding encoded PM data using a the one or more PM Encoding Type or Schema Version identified by the one or more PM Encoding Type or Schema Version Tags.

In at least one embodiment, an apparatus for providing Kafka header based schema version management includes a memory storing computer-readable instructions, and a processor connected to the memory, wherein the processor is configured to execute the computer-readable instructions to perform operations including preparing one or more Management Tags including one or more Encoding Type or Schema Version Tags based on one or more Encoding Type or Schema Source Files, encoding data using one or more of an Encoding Type or Schema Version identified by the one or more Encoding Type or Schema Version Tags to produce encoded data, embedding the one or more Encoding Type or Schema Version Tags in a Header of a Kafka Message, embedding the encoded data in a Message Body of the Kafka Message, and sending the Kafka Message to a Northbound Management System for decoding based on the one or more Encoding Type or Schema Version Tags in the Header of the Kafka Message.

In an apparatus according to at least one embodiment, the processor is further configured to prepare Additional Management Tags, wherein the Additional Management Tags include one or more a Base Station Identifier Tag, an Event Timestamp Tag, or a Reporting Out Period (ROP) Timestamp Tag, and to embed the Additional Management Tags into the Header of the Kafka Message.

In an apparatus according to at least one embodiment, the processor is further configured to implement a Fault Management (FM) Microservice, the FM Microservice preparing the one or more Encoding Type or Schema Version Tags by preparing an one or more FM Encoding Type or Schema Version Tags.

In an apparatus according to at least one embodiment, the FM Microservice is further configured to prepare the one or more Encoding Type or Schema Version Tags by preparing, by the FM Microservice, one or more FM Encoding Type or Schema Version Tags, to encode the data using the one or more Encoding Type or Schema Version identified by the one or more Encoding Type or Schema Version Tags to produce encoded data by encoding, by the FM Microservice, the data using the one or more Encoding Type or Schema Version identified by the one or more FM Encoding Type or Schema Version Tags to produce encoded FM data, to embed the one or more FM Encoding Type or Schema Version Tags in the Header of an FM Kafka Message by embedding, by the FM Microservice, the one or more FM Encoding Type or Schema Version Tags in the Header of the FM Kafka Message, to embed the encoded data in the Message Body of the Kafka Message by embedding, by the FM Microservice, the encoded FM data in the Message Body of the FM Kafka Message, and to send the Kafka Message to the Northbound Management System for decoding based on the one or more Encoding Type or Schema Version Tags in the Header of the Kafka Message by sending, by the FM Microservice, the FM Kafka Message to the Northbound Management System for decoding based on the one or more FM Encoding Type or Schema Version Tags in the Header of the FM Kafka Message.

In an apparatus according to at least one embodiment, the processor is further configured to embed the one or more FM Encoding Type or Schema Version Tags in the Header of the FM Kafka Message by embedding the one or more FM Encoding Type or Schema Version Tags in the Header of the FM Kafka Message useable for identifying an FM decoder configured for decoding encoded FM data using one or more FM Encoding Type or Schema Version identified by the one or more FM Encoding Type or Schema Version Tags.

In an apparatus according to at least one embodiment, the processor is further configured to implement a Performance Management (PM) Microservice, the PM Microservice is further configured to prepare the one or more Encoding Type or Schema Version Tags by preparing one or more PM Encoding Type or Schema Version Tags, to encode the data using the one or more Encoding Type or Schema Version identified by the one or more PM Encoding Type or Schema Version Tags to produce encoded data by encoding, by the PM Microservice, the data using a the one or more Encoding Type or Schema Version identified by the one or more PM Encoding Type or Schema Version Tags to produce encoded PM data, to embed the one or more Encoding Type or Schema Version Tags in the Header of a Kafka Message by embedding, by the PM Microservice, the one or more PM Encoding Type or Schema Version Tags, to embed the encoded data in the Message Body of the Kafka Message by embedding, by the PM Microservice, the encoded PM data in the Message Body of the PM Kafka Message, and to send the Kafka Message to the Northbound Management System for decoding based on the one or more Encoding Type or Schema Version Tags in the Header of the Kafka Message by sending the PM Kafka Message to the Northbound Management System for decoding based on one or more PM Encoding Type or Schema Version Tags in the Header of the PM Kafka Message.

In an apparatus according to at least one embodiment, the processor is further configured to embed the one or more PM Encoding Type or Schema Version Tags in the Header of the PM Kafka Message by embedding the one or more PM Encoding Type or Schema Version Tags in the Header of the PM Kafka Message useable by a Northbound Management System for identifying a PM decoder configured for decoding encoded PM data using one or more PM Encoding Type or Schema Version identified by the one or more PM Encoding Type or Schema Version Tags.

In at least one embodiment, a non-transitory computer-readable media having computer-readable instructions stored thereon, which when executed by a processor causes the processor to perform operations including preparing, by a microservice, one or more Management Tags including one or more Encoding Type or Schema Version Tags based on one or more Encoding Type or Schema Source Files used by the microservice, encoding, by the microservice, data using a corresponding one or more Encoding Type or Schema Version identified by the one or more Encoding Type or Schema Version Tags to produce encoded data, embedding, by the microservice, the one or more Encoding Type or Schema Version Tags in a Header of a Kafka Message, embedding, by the microservice, the encoded data in the Message Body of the Kafka Message, and sending the Kafka Message to a Northbound Management System for decoding based on the one or more Encoding Type or Schema Version Tags in the Header of the Kafka Message.

In a non-transitory computer-readable media according to at least one embodiment, the preparing, by the microservice, the one or more Management Tags further includes preparing Additional Management Tags, wherein the Additional Management Tags include one or more a Base Station Identifier Tag, an Event Timestamp Tag, or a Reporting Out Period (ROP) Timestamp Tag.

In a non-transitory computer-readable media according to at least one embodiment, the preparing, by the microservice, the one or more Encoding Type or Schema Version Tags further includes preparing, by a Fault Management (FM) Microservice, one or more FM Encoding Type or Schema Version Tags, the encoding, by the microservice, the data using the one or more Encoding Type or Schema Version identified by the one or more Encoding Type or Schema Version Tags to produce encoded data further includes encoding the data using the one or more Encoding Type or Schema Version identified by the one or more FM Encoding Type or Schema Version Tags to produce encoded FM data, the embedding the one or more Encoding Type or Schema Version Tags in the Header of a FM Kafka Message further includes embedding the one or more FM Encoding Type or Schema Version Tags in the Header of the FM Kafka Message, the embedding the encoded data in the Message Body of the Kafka Message further includes embedding the encoded FM data in the Message Body of the FM Kafka Message, and the sending the Kafka Message to the Northbound Management System for decoding based on the one or more Encoding Type or Schema Version Tags in the Header of the Kafka Message further includes sending the FM Kafka Message to the Northbound Management System for decoding based on the one or more FM Encoding Type or Schema Version Tags in the Header of the FM Kafka Message.

In a non-transitory computer-readable media according to at least one embodiment, the embedding the one or more FM Encoding Type or Schema Version Tags in the Header of the FM Kafka Message further includes embedding the one or more FM Encoding Type or Schema Version Tags in the Header of the FM Kafka Message useable for identifying an FM decoder configured for decoding encoded FM data using the one or more FM Encoding Type or Schema Version identified by the one or more FM Encoding Type or Schema Version Tags.

In a non-transitory computer-readable media according to at least one embodiment, the preparing, by the microservice, the one or more Encoding Type or Schema Version Tags further includes preparing, by a Performance Management (PM) Microservice, one or more PM Encoding Type or Schema Version Tags.

In a non-transitory computer-readable media according to at least one embodiment, the encoding the data using the one or more Encoding Type or Schema Version identified by the one or more Encoding Type or Schema Version Tags to produce encoded data further includes encoding the data using the one or more Encoding Type or Schema Version identified by the one or more PM Encoding Type or Schema Version Tags to produce encoded PM data, the embedding the one or more Encoding Type or Schema Version Tags in the Header of the Kafka Message further includes embedding the one or more PM Encoding Type or Schema Version Tags in the Header of the PM Kafka Message, the embedding the encoded data in the Message Body of the Kafka Message further includes embedding the encoded PM data in the Message Body of the PM Kafka Message, and the sending the Kafka Message to the Northbound Management System for decoding based on the one or more Encoding Type or Schema Version Tags in the Header of the Kafka Message further includes sending the PM Kafka Message to the Northbound Management System for decoding based on the one or more PM Encoding Type or Schema Version Tags in the Header of the PM Kafka Message.

Separate instances of these programs can be executed on or distributed across any number of separate computer systems. Thus, although certain steps have been described as being performed by certain devices, software programs, processes, or entities, this need not be the case. A variety of alternative implementations will be understood by those having ordinary skill in the art.

Additionally, those having ordinary skill in the art readily recognize that the techniques described above can be utilized in a variety of devices, environments, and situations. Although the embodiments have been described in language specific to structural features or methodological acts, the subject matter defined in the appended claims is not necessarily limited to the specific features or acts described. Rather, the specific features and acts are disclosed as exemplary forms of implementing the claims.

What is claimed is:

1. A method for providing Kafka header based schema management, comprising:
preparing, by a microservice, one or more Management Tags including one or more Encoding Type or Schema Version Tags based on one or more Encoding Type or Schema Source Files used by the microservice;
encoding, by the microservice, data using one or more of an Encoding Type or Schema Version identified by the one or more Encoding Type or Schema Version Tags to produce encoded data;
embedding, by the microservice, the one or more Encoding Type or Schema Version Tags in a Header of a Kafka Message;
embedding, by the microservice, the encoded data in a Message Body of the Kafka Message; and
sending the Kafka Message to a Northbound Management System for decoding based on the one or more Encoding Type or Schema Version Tags in the Header of the Kafka Message.

2. The method of claim 1, wherein the preparing, by the microservice, the one or more Management Tags further includes preparing Additional Management Tags, wherein the Additional Management Tags include one or more a Base Station Identifier Tag, an Event Timestamp Tag, or a Reporting Out Period (ROP) Timestamp Tag.

3. The method of claim 1, wherein:
the preparing, by the microservice, the one or more Encoding Type or Schema Version Tags further includes preparing, by a Fault Management (FM) Microservice, one or more FM Encoding Type or Schema Version Tags;
the encoding, by the microservice, data using the one or more Encoding Type or Schema Version identified by the one or more Encoding Type or Schema Version Tags to produce encoded data further includes encoding the data using the one or more Encoding Type or Schema Version identified by the one or more FM Encoding Type or Schema Version Tags to produce encoded FM data;
the embedding the one or more Encoding Type or Schema Version Tags in the Header of a FM Kafka Message further includes embedding the one or more FM Encoding Type or Schema Version Tags in the Header of the FM Kafka Message;
the embedding the encoded data in the Message Body of the Kafka Message further includes embedding the encoded FM data in the Message Body of the FM Kafka Message; and
the sending the Kafka Message to the Northbound Management System for decoding based on the one or more Encoding Type or Schema Version Tags in the Header of the Kafka Message further includes sending the FM Kafka Message to the Northbound Management System for decoding based on the one or more FM Encoding Type or Schema Version Tags in the Header of the FM Kafka Message.

4. The method of claim 3, wherein the embedding the one or more FM Encoding Type or Schema Version Tags in the Header of the FM Kafka Message further includes embedding the one or more FM Encoding Type or Schema Version Tags in the Header of the FM Kafka Message useable for identifying an FM decoder configured for decoding encoded FM data using the one or more FM Encoding Type or Schema Version identified by the one or more FM Encoding Type or Schema Version Tags.

5. The method of claim 1, wherein the preparing, by the microservice, the one or more Encoding Type or Schema Version Tags further includes preparing, by a Performance Management (PM) Microservice, one or more PM Encoding Type or Schema Version Tags.

6. The method of claim 5, wherein the encoding the data using the one or more Encoding Type or Schema Version identified by the one or more Encoding Type or Schema Version Tags to produce encoded data further includes encoding the data using the one or more Encoding Type or Schema Version identified by the one or more PM Encoding Type or Schema Version Tags to produce encoded PM data, the embedding the one or more Encoding Type or Schema Version Tags in the Header of the Kafka Message further includes embedding the one or more PM Encoding Type or Schema Version Tags in the Header of a PM Kafka Message, the embedding the encoded data in the Message Body of the Kafka Message further includes embedding the encoded PM data in the Message Body of the PM Kafka Message, and the sending the Kafka Message to the Northbound Management System for decoding based on the one or more Encoding Type or Schema Version Tags in the Header of the Kafka Message further includes sending the PM Kafka Message to the Northbound Management System for decoding based on the one or more PM Encoding Type or Schema Version Tags in the Header of the PM Kafka Message.

7. The method of claim 6, wherein the embedding the one or more PM Encoding Type or Schema Version Tags in the Header of the PM Kafka Message further includes embedding the one or more PM Encoding Type or Schema Version Tags in the Header of the PM Kafka Message useable for identifying a PM decoder configured for decoding encoded PM data using the one or more PM Encoding Type or Schema Version identified by the one or more PM Encoding Type or Schema Version Tags.

8. An apparatus for providing Kafka header based schema version management, comprising:
a memory storing computer-readable instructions; and
a processor connected to the memory, wherein the processor is configured to execute the computer-readable instructions to perform operations including:
preparing one or more Management Tags including one or more Encoding Type or Schema Version Tags based on one or more Encoding Type or Schema Source Files;
encoding data using one or more of an Encoding Type or Schema Version identified by the one or more Encoding Type or Schema Version Tags to produce encoded data;
embedding the one or more Encoding Type or Schema Version Tags in a Header of a Kafka Message;
embedding the encoded data in a Message Body of the Kafka Message; and
sending the Kafka Message to a Northbound Management System for decoding based on the one or more Encoding Type or Schema Version Tags in the Header of the Kafka Message.

9. The apparatus of claim 8, wherein the processor is further configured to prepare Additional Management Tags, wherein the Additional Management Tags include one or more a Base Station Identifier Tag, an Event Timestamp Tag, or a Reporting Out Period (ROP) Timestamp Tag, and to embed the Additional Management Tags into the Header of the Kafka Message.

10. The apparatus of claim 9, wherein the processor is further configured to implement a Fault Management (FM) Microservice, the FM Microservice preparing the one or more Encoding Type or Schema Version Tags by preparing an one or more FM Encoding Type or Schema Version Tags.

11. The apparatus of claim 10, wherein the FM Microservice is further configured:
to prepare the one or more Encoding Type or Schema Version Tags by preparing, by the FM Microservice, one or more FM Encoding Type or Schema Version Tags;
to encode the data using the one or more Encoding Type or Schema Version identified by the one or more Encoding Type or Schema Version Tags to produce encoded data by encoding, by the FM Microservice, the data using the one or more Encoding Type or Schema Version identified by the one or more FM Encoding Type or Schema Version Tags to produce encoded FM data,
to embed the one or more Encoding Type or Schema Version Tags in the Header of an Kafka Message by embedding, by the FM Microservice, the one or more FM Encoding Type or Schema Version Tags in the Header of the FM Kafka Message,
to embed the encoded data in the Message Body of the Kafka Message by embedding, by the FM Microservice, the encoded FM data in the Message Body of the FM Kafka Message, and
to send the Kafka Message to the Northbound Management System for decoding based on the one or more Encoding Type or Schema Version Tags in the Header of the Kafka Message by sending, by the FM Microservice, the FM Kafka Message to the Northbound Management System for decoding based on the one or more FM Encoding Type or Schema Version Tags in the Header of the FM Kafka Message.

12. The apparatus of claim 11, wherein the processor is further configured to embed the one or more FM Encoding Type or Schema Version Tags in the Header of the FM Kafka Message by embedding the one or more FM Encoding Type or Schema Version Tags in the Header of the FM Kafka Message useable for identifying an FM decoder configured for decoding encoded FM data using one or more FM Encoding Type or Schema Version identified by the one or more FM Encoding Type or Schema Version Tags.

13. The apparatus of claim 9, wherein the processor is further configured:
to implement a Performance Management (PM) Microservice, the PM Microservice is further configured to prepare the one or more Encoding Type or Schema Version Tags by preparing one or more PM Encoding Type or Schema Version Tags;
to encode the data using the one or more Encoding Type or Schema Version identified by the one or more Encoding Type or Schema Version Tags to produce encoded data by encoding, by the PM Microservice, the data using a the one or more Encoding Type or Schema Version identified by the one or more PM Encoding Type or Schema Version Tags to produce encoded PM data;
to embed the one or more Encoding Type or Schema Version Tags in the Header of a Kafka Message by embedding, by the PM Microservice, the one or more PM Encoding Type or Schema Version Tags in the Header of a PM Kafka Message;
to embed the encoded data in the Message Body of the PM Kafka Message by embedding, by the PM Microservice, the encoded PM data in the Message Body of the PM Kafka Message; and
to send the Kafka Message to the Northbound Management System for decoding based on the one or more Encoding Type or Schema Version Tags in the Header of the Kafka Message by sending the PM Kafka Message to the Northbound Management System for decoding based on one or more PM Encoding Type or Schema Version Tags in the Header of the PM Kafka Message.

14. The apparatus of claim 13, wherein the processor is further configured to embed the one or more PM Encoding Type or Schema Version Tags in the Header of the PM Kafka Message by embedding the one or more PM Encoding Type or Schema Version Tags in the Header of the PM Kafka Message useable by a Northbound Management System for identifying a PM decoder configured for decoding encoded PM data using one or more PM Encoding Type or Schema Version identified by the one or more PM Encoding Type or Schema Version Tags.

15. A non-transitory computer-readable media having computer-readable instructions stored thereon, which when executed by a processor causes the processor to perform operations comprising:
preparing, by a microservice, one or more Management Tags including one or more Encoding Type or Schema Version Tags based on one or more Encoding Type or Schema Source Files used by the microservice;
encoding, by the microservice, data using a corresponding one or more Encoding Type or Schema Version identified by the one or more Encoding Type or Schema Version Tags to produce encoded data;
embedding, by the microservice, the one or more Encoding Type or Schema Version Tags in a Header of a Kafka Message;
embedding, by the microservice, the encoded data in a Message Body of the Kafka Message; and
sending the Kafka Message to a Northbound Management System for decoding based on the one or more Encoding Type or Schema Version Tags in the Header of the Kafka Message.

16. The non-transitory computer-readable media of claim 15, wherein the preparing, by the microservice, the one or more Management Tags further includes preparing Additional Management Tags, wherein the Additional Management Tags include one or more a Base Station Identifier Tag, an Event Timestamp Tag, or a Reporting Out Period (ROP) Timestamp Tag.

17. The non-transitory computer-readable media of claim 15, wherein:
the preparing, by the microservice, the one or more Encoding Type or Schema Version Tags further includes preparing, by a Fault Management (FM) Microservice, one or more FM Encoding Type or Schema Version Tags;
the encoding, by the microservice, the data using the one or more Encoding Type or Schema Version identified by the one or more Encoding Type or Schema Version Tags to produce encoded data further includes encoding the data using the one or more Encoding Type or Schema Version identified by the one or more FM Encoding Type or Schema Version Tags to produce encoded FM data,
the embedding the one or more Encoding Type or Schema Version Tags in the Header of a FM Kafka Message further includes embedding the one or more FM Encoding Type or Schema Version Tags in the Header of the FM Kafka Message,
the embedding the encoded data in the Message Body of the Kafka Message further includes embedding the encoded FM data in the Message Body of the FM Kafka Message, and
the sending the Kafka Message to the Northbound Management System for decoding based on the one or more Encoding Type or Schema Version Tags in the Header of the Kafka Message further includes sending the FM Kafka Message to the Northbound Management System for decoding based on the one or more FM Encoding Type or Schema Version Tags in the Header of the FM Kafka Message.

18. The non-transitory computer-readable media of claim 17, wherein the embedding the one or more FM Encoding Type or Schema Version Tags in the Header of the FM Kafka Message further includes embedding the one or more FM Encoding Type or Schema Version Tags in the Header of the FM Kafka Message useable for identifying an FM decoder configured for decoding encoded FM data using the one or more FM Encoding Type or Schema Version identified by the one or more FM Encoding Type or Schema Version Tags.

19. The non-transitory computer-readable media of claim 15, wherein the preparing, by the microservice, the one or more Encoding Type or Schema Version Tags further includes preparing, by a Performance Management (PM) Microservice, one or more PM Encoding Type or Schema Version Tags.

20. The non-transitory computer-readable media of claim 19, wherein:
the encoding the data using the one or more Encoding Type or Schema Version identified by the one or more Encoding Type or Schema Version Tags to produce encoded data further includes encoding the data using the one or more Encoding Type or Schema Version identified by the one or more PM Encoding Type or Schema Version Tags to produce encoded PM data;
the embedding the one or more Encoding Type or Schema Version Tags in the Header of the Kafka Message further includes embedding the one or more PM Encoding Type or Schema Version Tags in the Header of a PM Kafka Message;
the embedding the encoded data in the Message Body of the Kafka Message further includes embedding the encoded PM data in the Message Body of the PM Kafka Message; and
the sending the Kafka Message to the Northbound Management System for decoding based on the one or more Encoding Type or Schema Version Tags in the Header of the Kafka Message further includes sending the PM Kafka Message to the Northbound Management System for decoding based on the one or more PM Encoding Type or Schema Version Tags in the Header of the PM Kafka Message.
